(19) United States
(12) Patent Application Publication
(10) Pub. No.: US 2024/0172075 A1
(43) Pub. Date: May 23, 2024

(54) SYSTEMS AND METHODS FOR MANAGING AND TRIGGERING HANDOVERS OF MOBILE ACCESS POINTS IN A NETWORK OF MOVING THINGS, FOR EXAMPLE INCLUDING A NETWORK OF AUTONOMOUS VEHICLES

(71) Applicant: Veniam, Inc., Mountain View, CA (US)

(72) Inventors: Tiago Silvestre Condeixa, Vagos (PT); Diogo Miguel Augusto Lopes, Esgueira (PT); Henrique Manuel Pereira Cabral, Senhora da Hora (PT); Ricardo Jorge Magalhães de Matos, Porto (PT)

(21) Appl. No.: 18/119,466

(22) Filed: Mar. 9, 2023

Related U.S. Application Data
(63) Continuation of application No. 15/352,953, filed on Nov. 16, 2016, now abandoned.
(60) Provisional application No. 62/281,432, filed on Jan. 21, 2016.

(51) Int. Cl. H04W 36/18; H04B 17/27; H04B 17/318; H04L 67/10; H04L 67/12; H04L 67/53; H04L 69/40; H04W 4/40; H04W 36/00

(52) U.S. Cl. CPC H04W 36/18; H04B 17/27; H04B 17/318; H04L 67/10; H04L 67/12; H04L 67/53; H04L 69/40; H04W 4/40; H04W 36/0022; H04W 36/32

(57) ABSTRACT

Communication network architectures, systems and methods for supporting a network of mobile nodes. As a non-limiting example, various aspects of this disclosure provide detail of a method, a system, and a non-transitory storage medium for managing and triggering handover of a mobile network node in a network of moving things comprising a plurality of network nodes.

### CROSS-REFERENCE TO RELATED APPLICATIONS/INCORPORATION BY REFERENCE

This patent application makes reference to, claims priority to, and claims benefit from U.S. Provisional Patent Application Ser. No. 62/281,432, filed on Jan. 21, 2016, and titled “Systems and Methods for Managing and Triggering Handovers of Mobile Access Points in a Network of Moving Things,” which is hereby incorporated herein by reference in its entirety. The present application is also related to U.S. Provisional Application Ser. No. 62/221,997, titled “Integrated Communication Network for a Network of Moving Things,” filed on Sep. 22, 2015; U.S. Provisional Application Ser. No. 62/222,016, titled “Systems and Methods for Synchronizing a Network of Moving Things,” filed on Sep. 22, 2015; U.S. Provisional Application Ser. No. 62/222,042, titled “Systems and Methods for Managing a Network of Moving Things,” filed on Sep. 22, 2015; U.S. Provisional Application Ser. No. 62/222,066, titled “Systems and Methods for Monitoring a Network of Moving Things,” filed on Sep. 22, 2015; U.S. Provisional Application Ser. No. 62/222,077, titled “Systems and Methods for Detecting and Classifying Anomalies in a Network of Moving Things,” filed on Sep. 22, 2015; U.S. Provisional Application Ser. No. 62/222,098, titled “Systems and Methods for Managing Mobility in a Network of Moving Things,” filed on Sep. 22, 2015; U.S. Provisional Application Ser. No. 62/222,121, titled “Systems and Methods for Managing Connectivity a Network of Moving Things,” filed on Sep. 22, 2015; U.S. Provisional Application Ser. No. 62/222,135, titled “Systems and Methods for Collecting Sensor Data in a Network of Moving Things,” filed on Sep. 22, 2015; U.S. Provisional Application Ser. No. 62/222,145, titled “Systems and Methods for Interfacing with a Network of Moving Things,” filed on Sep. 22, 2015; U.S. Provisional Application Ser. No. 62/222,150, titled “Systems and Methods for Interfacing with a User of a Network of Moving Things,” filed on Sep. 22, 2015; U.S. Provisional Application Ser. No. 62/222,168, titled “Systems and Methods for Data Storage and Processing for a Network of Moving Things,” filed on Sep. 22, 2015; U.S. Provisional Application Ser. No. 62/222,183, titled “Systems and Methods for Vehicle Traffic Management in a Network of Moving Things,” filed on Sep. 22, 2015; U.S. Provisional Application Ser. No. 62/222,186, titled “Systems and Methods for Environmental Management in a Network of Moving Things,” filed on Sep. 22, 2015; U.S. Provisional Application Ser. No. 62/222,190, titled “Systems and Methods for Port Management in a Network of Moving Things,” filed on Sep. 22, 2015; U.S. Provisional Patent Application Ser. No. 62/222,192, titled “Communication Network of Moving Things,” filed on Sep. 22, 2015; U.S. Provisional Application Ser. No. 62/244,828, titled “Utilizing Historical Data to Correct GPS Data in a Network of Moving Things,” filed on Oct. 22, 2015; U.S. Provisional Application Ser. No. 62/244,930, titled “Using Anchors to Correct GPS Data in a Network of Moving Things,” filed on Oct. 22, 2015; U.S. Provisional Application Ser. No. 62/246,368, titled “Systems and Methods for Inter-Application Communication in a Network of Moving Things,” filed on Oct. 26, 2015; U.S. Provisional Application Ser. No. 62/246,372, titled “Systems and Methods for Probing and Validating Communication in a Network of Moving Things,” filed on Oct. 26, 2015; U.S. Provisional Application Ser. No. 62/250,544, titled “Adaptive Rate Control for Vehicular Networks,” filed on Nov. 4, 2015; U.S. Provisional Application Ser. No. 62/273,878, titled “Systems and Methods for Reconfiguring and Adapting Hardware in a Network of Moving Things,” filed on Dec. 31, 2015; U.S. Provisional Application Ser. No. 62/253,249, titled “Systems and Methods for Optimizing Data Gathering in a Network of Moving Things,” filed on Nov. 10, 2015; U.S. Provisional Application Ser. No. 62/257,421, titled “Systems and Methods for Delay Tolerant Networking in a Network of Moving Things,” filed on Nov. 19, 2015; U.S. Provisional Application Ser. No. 62/265,267, titled “Systems and Methods for Improving Coverage and Throughput of Mobile Access Points in a Network of Moving Things,” filed on Dec. 9, 2015; U.S. Provisional Application Ser. No. 62/270,858, titled “Channel Coordination in a Network of Moving Things,” filed on Dec. 22, 2015; U.S. Provisional Application Ser. No. 62/257,854, titled “Systems and Methods for Network Coded Mesh Networking in a Network of Moving Things,” filed on Nov. 20, 2015; U.S. Provisional Application Ser. No. 62/260,749, titled “Systems and Methods for Improving Fixed Access Point Coverage in a Network of Moving Things,” filed on Nov. 30, 2015; U.S. Provisional Application Ser. No. 62/273,715, titled “Systems and Methods for Managing Mobility Controllers and Their Network Interactions in a Network of Moving Things,” filed on Dec. 31, 2015; U.S. Provisional Application Ser. No. 62/281,432, titled “Systems and Methods for Managing and Triggering Handovers of Mobile Access Points in a Network of Moving Things,” filed on Jan. 21, 2016; U.S. Provisional Application Ser. No. 62/268,188, titled “Captive Portal-related Control and Management in a Network of Moving Things,” filed on Dec. 16, 2015; U.S. Provisional Application Ser. No. 62/270,678, titled “Systems and Methods to Extrapolate High-Value Data from a Network of Moving Things,” filed on Dec. 22, 2015; U.S. Provisional Application Ser. No. 62/272,750, titled “Systems and Methods for Remote Software Update and Distribution in a Network of Moving Things,” filed on Dec. 30, 2015; U.S. Provisional Application Ser. No. 62/278,662, titled “Systems and Methods for Remote Configuration Update and Distribution in a Network of Moving Things,” filed on Jan. 14, 2016; U.S. Provisional Application Ser. No. 62/286,243, titled “Systems and Methods for Adapting a Network of Moving Things Based on User Feedback,” filed on Jan. 22, 2016; U.S. Provisional Application Ser. No. 62/278,764, titled “Systems and Methods to Guarantee Data Integrity When Building Data Analytics in a Network of Moving Things,” Jan. 14, 2016; U.S. Provisional Application Ser. No. 62/286,515, titled “Systems and Methods for Self-Initialization and Automated Bootstrapping of Mobile Access Points in a Network of Moving Things,” filed on Jan. 25, 2016; U.S. Provisional Application Ser. No. 62/295,602, titled “Systems and Methods for Power Management in a Network of Moving Things,” filed on Feb. 16, 2016; and U.S. Provisional Application Ser. No. 62/299,269, titled “Systems and Methods for Automating and Easing the Installation and Setup of the Infrastructure Supporting a Network of Moving Things,” filed on Feb. 24, 2016; each of which is hereby incorporated herein by reference in its entirety for all purposes.

### BACKGROUND

Current communication networks are unable to adequately support communication environments involving mobile and static nodes. As a non-limiting example, current communication networks are unable to adequately support a network comprising a complex array of both moving and static nodes (e.g., the Internet of moving things, autonomous vehicle networks, etc.). Limitations and disadvantages of conventional methods and systems will become apparent to one of skill in the art, through comparison of such approaches with some aspects of the present methods and systems set forth in the remainder of this disclosure with reference to the drawings.

### BRIEF DESCRIPTION OF SEVERAL VIEWS OF THE DRAWINGS

FIG. 1 shows a block diagram of a communication network, in accordance with various aspects of this disclosure.

FIG. 2 shows a block diagram of a communication network, in accordance with various aspects of this disclosure.

FIG. 3 shows a diagram of a metropolitan area network, in accordance with various aspects of this disclosure.

FIG. 4 shows a block diagram of a communication network, in accordance with various aspects of this disclosure.

FIGS. 5A-5C show a plurality of network configurations illustrating the flexibility and/or and resiliency of a communication network, in accordance with various aspects of this disclosure.

FIG. 6 shows a block diagram of an example communication network, in accordance with various aspects of the present disclosure.

FIG. 8 shows a flow diagram of a method of handing off a mobile access point, in accordance with various aspects of the present disclosure.

FIGS. 9A-9C shows block diagrams illustrating various aspects of the example method of FIG. 8, in accordance with various aspects of the present disclosure.

FIG. 10 shows a flow diagram of a method of handing off a mobile access point, in accordance with various aspects of the present disclosure.

FIGS. 11A-11B show block diagrams illustrating various aspects of the example method of FIG. 10, in accordance with various aspects of the present disclosure.

FIG. 12 shows a block diagram of various components of an example mobile access point, in accordance with various aspects of the present disclosure.

FIG. 13 shows a block diagram of various components of an example network controller, in accordance with various aspects of the present disclosure.

### SUMMARY

Various aspects of this disclosure provide systems and methods for initiating and/or managing the handoff (or handover) of mobile access points. As non-limiting examples, various aspects of this disclosure provide systems and methods for control signaling and data routing in the context of a mobile access point handoff.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (i.e., hardware) and any software and/or firmware (“code”) that may configure the hardware, be executed by the hardware, and or otherwise be associated with the hardware.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or”. As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or x” means “one or more of x, y, and z.” As utilized herein, the terms “e.g.,” and “for example,” “exemplary,” and the like set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

With the proliferation of the mobile and/or static things (e.g., devices, machines, people, etc.) and logistics for such things to become connected to each other (e.g., in the contexts of smart logistics, transportation, environmental sensing, etc.), a platform that is for example always-on, robust, scalable and secure that is capable of providing connectivity, services and Internet access to such things (or objects), anywhere and anytime is desirable. Efficient power utilization within the various components of such system is also desirable.

Accordingly, various aspects of the present disclosure provide a fully-operable, always-on, responsive, robust, scalable, secure platform/system/architecture to provide connectivity, services and Internet access to all mobile things and/or static things (e.g., devices, machines, people, access points, end user devices, sensors, etc.) anywhere and anytime, while operating in an energy-efficient manner.

Various aspects of the present disclosure provide a platform that is flexibly configurable and adaptable to the various requirements, features, and needs of different environments, where each environment may be characterized by a respective level of mobility and density of mobile and/or static things, and the number and/or types of access to those things. Characteristics of various environments may, for example, include high mobility of nodes (e.g., causing contacts or connections to be volatile), high number of neighbors, high number of connected mobile users, mobile access points, availability of multiple networks and technologies (e.g., sometimes within a same area), etc. For example, the mode of operation of the platform may be flexibly adapted from environment to environment, based on each environment's respective requirements and needs, which may be different from other environments. Additionally for example, the platform may be flexibly optimized (e.g., at design/installation time and/or in real-time) for different purposes (e.g., to reduce the latency, increase throughput, reduce power consumption, load balance, increase reliability, make more robust with regard to failures or other disturbances, etc.), for example based on the content, service or data that the platform provides or handles within a particular environment.

In accordance with various aspects of the present disclosure, many control and management services (e.g., mobility, security, routing, etc.) are provided on top of the platform (e.g., directly, using control overlays, using containers, etc.), such services being compatible with the services currently deployed on top of the Internet or other communication network(s).

The communication network (or platform), in whole or in part, may for example be operated in public and/or private modes of operation, for example depending on the use case. The platform may, for example, operate in a public or private mode of operation, depending on the use-case (e.g., public Internet access, municipal environment sensing, fleet operation, etc.).

Additionally for example, in an implementation in which various network components are mobile, the transportation and/or signal control mechanisms may be adapted to serve the needs of the particular implementation. Also for example, wireless transmission power and/or rate may be adapted (e.g., to mitigate interference, to reduce power consumption, to extend the life of network components, etc.

Various example implementations of a platform, in accordance with various aspects of the present disclosure, are capable of connecting different subsystems, even when various other subsystems that may normally be utilized are unavailable. For example, the platform may comprise various built-in redundancies and fail-recovery mechanisms. For example, the platform may comprise a self-healing capability, self-configuration capability, self-adaptation capability, etc. The protocols and functions of the platform may, for example, be prepared to be autonomously and smoothly configured and adapted to the requirements and features of different environments characterized by different levels of mobility and density of things (or objects), the number/types of access to those things. For example, various aspects of the platform may gather context parameters that can influence any or all decisions. Such parameters may, for example, be derived locally, gathered from a neighborhood, fixed APs, the Cloud, etc. Various aspects of the platform may also, for example, ask for historical information to feed any of the decisions, where such information can be derived from historical data, from surveys, from simulators, etc. Various aspects of the platform may additionally, for example, probe or monitor decisions made throughout the network, for example to evaluate the network and/or the decisions themselves in real-time. Various aspects of the platform may further, for example, enforce the decisions in the network (e.g., after evaluating the probing results). Various aspects of the platform may, for example, establish thresholds to avoid any decision that is to be constantly or repeatedly performed without any significant advantage (e.g., technology change, certificate change, IP change, etc.). Various aspects of the platform may also, for example, learn locally (e.g., with the decisions performed) and dynamically update the decisions.

In addition to (or instead of) failure robustness, a platform may utilize multiple connections (or pathways) that exist between distinct sub-systems or elements within the same sub-system, to increase the robustness and/or load-balancing of the system.

The following discussion will present examples of the functionality performed by various example subsystems of the communication network. It should be understood that the example functionality discussed herein need not be performed by the particular example subsystem or by a single subsystem. For example, the subsystems present herein may interact with each other, and data or control services may be deployed either in a centralized way, or having their functionalities distributed among the different subsystems, for example leveraging the cooperation between the elements of each subsystem.

Various aspects of the present disclosure provide a communication network (e.g., a city-wide vehicular network, a shipping port-sized vehicular network, a campus-wide vehicular network, etc.) that utilizes vehicles (e.g., automobiles, buses, trucks, boats, forklifts, human-operated vehicles, autonomous and/or remote controlled vehicles, etc.) as Wi-Fi hotspots. Note that Wi-Fi is generally used throughout this discussion as an example, but the scope of various aspects of this disclosure is not limited thereto. For example, other wireless LAN technologies, PAN technologies, MAN technologies, etc., may be utilized. Such utilization may, for example, provide cost-effective ways to gather substantial amounts of urban data, and provide for the efficient offloading of traffic from congested cellular networks (or other networks). In controlled areas (e.g., ports, harbors, etc.) with many vehicles, a communication network in accordance with various aspects of this disclosure may expand the wireless coverage of existing enterprise Wi-Fi networks, for example providing for real-time communication with vehicle drivers (e.g., human, computer-controlled, etc.) and other mobile employees without the need for SIM cards or cellular (or other network) data plans.

Vehicles may have many advantageous characteristics that make them useful as Wi-Fi (or general wireless) hotspots. For example, vehicles generally have at least one battery, vehicles are generally densely spread over the city at street level and/or they are able to establish many contacts with each other in a controlled space, and vehicles can communicate with 10× the range of normal Wi-Fi in the 5.9 GHz frequency band, reserved for intelligent transportation systems in the EU, the U.S., and elsewhere. Note that the scope of this disclosure is not limited to such 5.9 GHz wireless communication. Further, vehicles are able to effectively expand their coverage area into a swath over a period of time, enabling a single vehicle access point to interact with substantially more data sources over the period of time.

In accordance with various aspects of the present disclosure, an affordable multi-network on-board unit (OBU) is presented. Note that the OBU may also be referred to herein as a mobile access point, Mobile AP, MAP, etc. The OBU may, for example, comprise a plurality of networking interfaces (e.g., Wi-Fi, 802.11p, 4G, Bluetooth, UWB, etc.). The OBU may, for example, be readily installed in or on private and/or public vehicles (e.g., individual user vehicles, vehicles of private fleets, vehicles of public fleets, etc.). The OBU may, for example, be installed in transportation fleets, waste management fleets, law enforcement fleets, emergency services, road maintenance fleets, taxi fleets, aircraft fleets, etc. The OBU may, for example, be installed in or on a vehicle or other structure with free mobility or relatively limited mobility. The OBU may also, for example, be carried by a person or service animal, mounted to a bicycle, mounted to a moving machine in general, mounted to a container, etc.

The OBUs may, for example, operate to connect passing vehicles to the wired infrastructure of one or more network providers, telecom operators, etc. In accordance with the architecture, hardware, and software functionality discussed herein, vehicles and fleets can be connected not just to the cellular networks (or other wide area or metropolitan area networks, etc.) and existing Wi-Fi hotspots spread over a city or a controlled space, but also to other vehicles (e.g., utilizing multi-hop communications to a wired infrastructure, single or multi-hop peer-to-peer vehicle communication, etc.). The vehicles and/or fleets may, for example, form an overall mesh of communication links, for example including the OBUs and also fixed Access Points (APs) connected to the wired infrastructure (e.g., a local infrastructure, etc.). Note that OBUs herein may also be referred to as “Mobile APs,” “mobile hotspots,” “MAPs,” etc. Also note that fixed access points may also be referred to herein as Road Side Units (RSUs), Fixed APs, FAPs, etc.

In an example implementation, the OBUs may communicate with the Fixed APs utilizing a relatively long-range protocol (e.g., 802.11p, etc.), and the Fixed APs may, in turn, be hard wired to the wired infrastructure (e.g., via cable, tethered optical link, etc.). Note that Fixed APs may also, or alternatively, be coupled to the infrastructure via wireless link (e.g., 802.11p, etc.). Additionally, clients or user devices may communicate with the OBUs using one or more relatively short-range protocols (e.g., Wi-Fi, Bluetooth, UWB, etc.). The OBUs, for example having a longer effective wireless communication range than typical Wi-Fi access points or other wireless LAN/PAN access points (e.g., at least for links such as those based on 802.11p, etc.), are capable of substantially greater coverage areas than typical Wi-Fi or other wireless LAN/PAN access points, and thus fewer OBUs are necessary to provide blanket coverage over a geographical area.

The OBU may, for example, comprise a robust vehicular networking module (e.g., a connection manager) which builds on long-range communication protocol capability (e.g., 802.11p, etc.). For example, in addition to comprising 802.11p (or other long-range protocol) capability to communicate with Fixed APs, vehicles, and other nodes in the network, the OBU may comprise a network interface (e.g., 802.11a/b/g/n, 802.11ac, 802.11af, any combination thereof, etc.) to provide wireless local area network (WLAN) connectivity to end user devices, sensors, fixed Wi-Fi access points, etc. For example, the OBU may operate to provide in-vehicle Wi-Fi Internet access to users in and/or around the vehicle (e.g., a bus, train car, taxi cab, public works vehicle, etc.). The OBU may further comprise one or more wireless backbone communication interfaces (e.g., cellular network interfaces, etc.). Though in various example scenarios, a cellular network interface (or other wireless backbone communication interface) might not be the preferred interface for various reasons (e.g., cost, power, bandwidth, etc.), the cellular network interface may be utilized to provide connectivity in geographical areas that are not presently supported by a Fixed AP, may be utilized to provide a fail-over communication link, may be utilized for emergency communications, may be utilized to subscribe to local infrastructure access, etc. The cellular network interface may also, for example, be utilized to allow the deployment of solutions that are dependent on the cellular network operators.

An OBU, in accordance with various aspects of the present disclosure, may for example comprise a smart connection manager that can select the best available wireless link(s) (e.g., Wi-Fi, 802.11p, cellular, vehicle mesh, etc.) with which to access the Internet. The OBU may also, for example, provide geo-location capabilities (e.g., GPS, etc.), motion detection sensors to determine if the vehicle is in motion, and a power control subsystem (e.g., to ensure that the OBU does not deplete the vehicle battery, etc.). The OBU may, for example, comprise any or all of the sensors (e.g., environmental sensors, etc.) discussed herein.

The OBU may also, for example, comprise a manager that manages machine-to-machine data acquisition and transfer (e.g., in a real-time or delay-tolerant fashion) to and from the cloud. For example, the OBU may log and/or communicate information of the vehicles.

The OBU may, for example, comprise a connection and/or routing manager that operates to perform routing of communications in a vehicle-to-vehicle/vehicle-to-infrastructure multi-hop communication. A mobility manager (e.g., mobility controller (MC), or network controller, NC) may, for example, ensure that communication sessions persist over one or more handoff(s) (also referred to herein as a “handover” or “handovers”) (e.g., between different Mobile APs, Fixed APs, base stations, hot spots, etc.), among different technologies (e.g., 802.11p, cellular, Wi-Fi, satellite, etc.), among different MCs (e.g., in a fail-over scenario, load redistribution scenario, etc.), across different interfaces (or ports), etc. Note that the MC may also be referred to herein as a Local Mobility Anchor (LMA), a Network Controller, etc. Note that the MC, or a plurality thereof, may for example be implemented as part of the backbone, but may also, or alternatively, be implemented as part of any of a variety of components or combinations thereof. For example, the MC may be implemented in a Fixed AP (or distributed system thereof), as part of an OBU (or a distributed system thereof), etc. Various non-limiting examples of system components and/or methods are provided in U.S. Provisional Application No. 62/222,098, filed Sep. 22, 2015, and titled “Systems and Method for Managing Mobility in a Network of Moving Things,” the entire contents of which are hereby incorporated herein by reference. Note that in an example implementation including a plurality of MCs, such MCs may be co-located and/or may be geographically distributed.

Various aspects of the present disclosure also provide a cloud-based service-oriented architecture that handles the real-time management, monitoring and reporting of the network and clients, the functionalities required for data storage, processing and management, the Wi-Fi client authentication and Captive Portal display, etc.

A communication network (or component thereof) in accordance with various aspects of the present disclosure may, for example, support a wide range of smart city applications (or controlled scenarios, or connected scenarios, etc.) and/or use-cases, as described herein.

For example, an example implementation may operate to turn each vehicle (e.g., both public and private taxis, buses, trucks, etc.) into a Mobile AP (e.g., a mobile Wi-Fi hotspot), offering Internet access to employees, passengers and mobile users travelling in the city, waiting in bus stops, sitting in parks, etc. Moreover, through an example vehicular mesh network formed between vehicles and/or fleets of vehicles, an implementation may be operable to offload cellular traffic through the mobile Wi-Fi hotspots and/or fixed APs (e.g., 802.11p-based APs) spread over the city and connected to the wired infrastructure of public or private telecom operators in strategic places, while ensuring the widest possible coverage at the lowest possible cost.

An example implementation (e.g., of a communication network and/or components thereof) may, for example, be operable as a massive urban scanner that gathers large amounts of data (e.g., continuously) on-the-move, actionable or not, generated by a myriad of sources spanning from the in-vehicle sensors or On Board Diagnostic System port (e.g., OBD2, etc.), interface with an autonomous vehicle driving system, external Wi-Fi/Bluetooth-enabled sensing units spread over the city, devices of vehicles' drivers and passengers (e.g., information characterizing such devices and/or passengers, etc.), positioning system devices (e.g., position information, velocity information, trajectory information, travel history information, etc.), etc.

Depending on the use case, the OBU may for example process (or computer, transform, manipulate, aggregate, summarize, etc.) the data before sending the data from the vehicle, for example providing the appropriate granularity (e.g., value resolution) and sampling rates (e.g., temporal resolution) for each individual application. For example, the OBU may, for example, process the data in any manner deemed advantageous by the system. The OBU may, for example, send the collected data (e.g., raw data, preprocessed data, information of metrics calculated based on the collected data, etc.) to the Cloud (e.g., to one or more networked servers coupled to any portion of the network) in an efficient and reliable manner to improve the efficiency, environmental impact and social value of municipal city operations and transportation services. Various example use cases are described herein.

In an example scenario in which public buses are moving along city routes and/or taxis are performing their private transportation services, the OBU is able to collect large quantities of real-time data from the positioning systems (e.g., GPS, etc.), from accelerometer modules, etc. The OBU may then, for example, communicate such data to the Cloud, where the data may be processed, reported and viewed, for example to support such public or private bus and/or taxi operations, for example supporting efficient remote monitoring and scheduling of buses and taxis, respectively.

In an example implementation, small cameras (or other sensors) may be coupled to small single-board computers (SBCs) that are placed above the doors of public buses to allow capturing image sequences of people entering and leaving buses, and/or on stops along the bus routes in order to estimate the number of people waiting for a bus. Such data may be gathered by the OBU in order to be sent to the Cloud. With such data, public transportation systems may detect peaks; overcrowded buses, routes and stops; underutilized buses, routes and stops; etc., enabling action to be taken in real-time (e.g., reducing bus periodicity to decrease fuel costs and CO₂ emissions where and when passenger flows are smaller, etc.) as well as detecting systematic transportation problems.

An OBU may, for example, be operable to communicate with any of a variety of Wi-Fi-enabled sensor devices equipped with a heterogeneous collection of environmental sensors. Such sensors may, for example, comprise noise sensors (microphones, etc.), gas sensors (e.g., sensing CO, NO₂, O₃, volatile organic compounds (or VOCs), CO₂, etc.), smoke sensors, pollution sensors, meteorological sensors (e.g., sensing temperature, humidity, luminosity, particles, solar radiation, wind speed (e.g., anemometer), wind direction, rain (e.g., a pluviometer), optical scanners, biometric scanners, cameras, microphones, etc.). Such sensors may also comprise sensors associated with users (e.g., vehicle operators or passengers, passersby, etc.) and/or their personal devices (e.g., smart phones or watches, biometrics sensors, wearable sensors, implanted sensors, etc.). Such sensors may, for example, comprise sensors and/or systems associated with on-board diagnostic (OBD) units for vehicles, autonomous vehicle driving systems, etc. Such sensors may, for example, comprise positioning sensors (e.g., GPS sensors, Galileo sensors, GLONASS sensors, etc.). Note that such positioning sensors may be part of a vehicle's operational system (e.g., a local human-controlled vehicle, an autonomous vehicle, a remote human-controlled vehicle, etc.) Such sensors may, for example, comprise container sensors (e.g., garbage can sensors, shipping container sensors, container environmental sensors, container tracking sensors, etc.).

Once a vehicle enters the vicinity of such a sensor device, a wireless link may be established, so that the vehicle (or OBU thereof) can collect sensor data from the sensor device and upload the collected data to a database in the Cloud. The appropriate action can then be taken. In an example waste management implementation, several waste management (or collection) trucks may be equipped with OBUs that are able to periodically communicate with sensors installed on containers in order to gather information about waste level, time passed since last collection, etc. Such information may then sent to the Cloud (e.g., to a waste management application coupled to the Internet, etc.) through the vehicular mesh network, in order to improve the scheduling and/or routing of waste management trucks. Note that various sensors may always be in range of the Mobile AP (e.g., vehicle-mounted sensors). Note that the sensor may also (or alternatively) be mobile (e.g., a sensor mounted to another vehicle passing by a Mobile AP or Fixed AP, a drone-mounted sensor, a pedestrian-mounted sensor, etc.).

In an example implementation, for example in a controlled space (e.g., a port, harbor, airport, factory, plantation, mine, etc.) with many vehicles, machines and employees, a communication network in accordance with various aspects of the present disclosure may expand the wireless coverage of enterprise and/or local Wi-Fi networks, for example without resorting to a Telco-dependent solution based on SIM cards or cellular fees. In such an example scenario, apart from avoiding expensive cellular data plans, limited data rate and poor cellular coverage in some places, a communication network in accordance with various aspects of the present disclosure is also able to collect and/or communicate large amounts of data, in a reliable and real-time manner, where such data may be used to optimize harbor logistics, transportation operations, etc.

For example in a port and/or harbor implementation, by gathering real-time information on the position, speed, fuel consumption and CO₂ emissions of the vehicles, the communication network allows a port operator to improve the coordination of the ship loading processes and increase the throughput of the harbor. Also for example, the communication network enables remote monitoring of drivers' behaviors, behaviors of autonomous vehicles and/or control systems thereof, trucks' positions and engines' status, and then be able to provide real-time notifications to drivers (e.g., to turn on/off the engine, follow the right route inside the harbor, take a break, etc.), for example human drivers and/or automated vehicle driving systems, thus reducing the number and duration of the harbor services and trips. Harbor authorities may, for example, quickly detect malfunctioning trucks and abnormal trucks' circulation, thus avoiding accidents in order to increase harbor efficiency, security, and safety. Additionally, the vehicles can also connect to Wi-Fi access points from harbor local operators, and provide Wi-Fi Internet access to vehicles' occupants and surrounding harbor employees, for example allowing pilots to save time by filing reports via the Internet while still on the water.

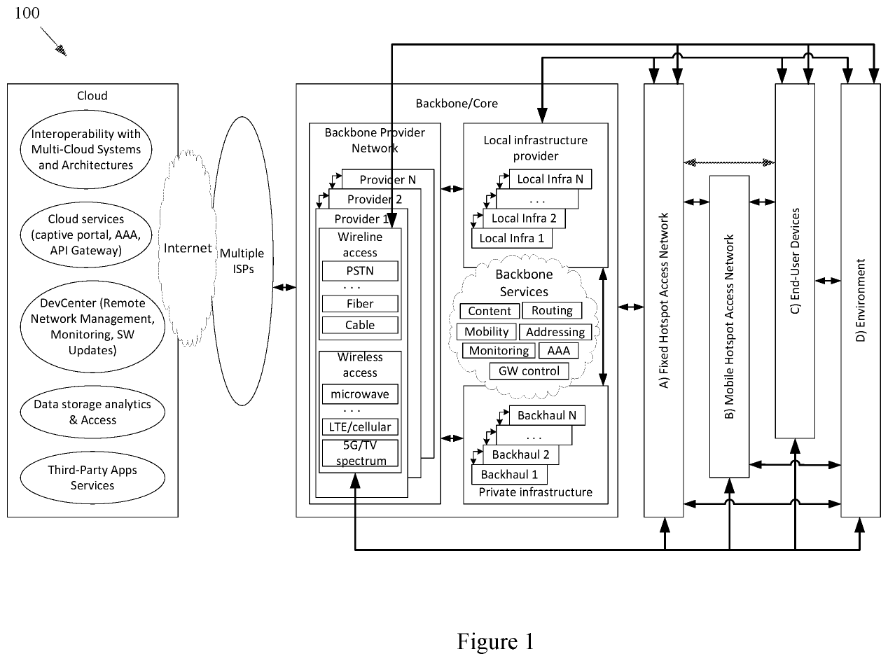

FIG. 1 shows a block diagram of a communication network 100, in accordance with various aspects of this disclosure. Any or all of the functionality discussed herein may be performed by any or all of the example components of the example network 100. Also, the example network 100 may, for example, share any or all characteristics with the other example networks and/or network components 200, 300, 400, 500-570, and 600, discussed herein.

The example network 100, for example, comprises a Cloud that may, for example comprise any of a variety of network level components. The Cloud may, for example, comprise any of a variety of server systems executing applications that monitor and/or control components of the network 100. Such applications may also, for example, manage the collection of information from any of a large array of networked information sources, many examples of which are discussed herein. The Cloud (or a portion thereof) may also be referred to, at times, as an API. For example, Cloud (or a portion thereof) may provide one or more application programming interfaces (APIs) which other devices may use for communicating/interacting with the Cloud.

An example component of the Cloud may, for example, manage interoperability with various multi-cloud systems and architectures. Another example component (e.g., a Cloud service component) may, for example, provide various cloud services (e.g., captive portal services, authentication, authorization, and accounting (AAA) services, API Gateway services, etc.). An additional example component (e.g., a DevCenter component) may, for example, provide network monitoring and/or management functionality, manage the implementation of software updates, etc. A further example component of the Cloud may manage data storage, data analytics, data access, etc. A still further example component of the Cloud may include any of a variety of third-partly applications and services.

The Cloud may, for example, be coupled to the Backbone/Core Infrastructure of the example network 100 via the Internet (e.g., utilizing one or more Internet Service Providers). Though the Internet is provided by example, it should be understood that scope of the present disclosure is not limited thereto.

The Backbone/Core may, for example, comprise any one or more different communication infrastructure components. For example, one or more providers may provide backbone networks or various components thereof. As shown in the example network 100 illustrated in FIG. 1, a Backbone provider may provide wireline access (e.g., PSTN, fiber, cable, etc.). Also for example, a Backbone provider may provide wireless access (e.g., Microwave, LTE/Cellular, 5G/TV Spectrum, etc.).

The Backbone/Core may also, for example, comprise one or more Local Infrastructure Providers. The Backbone/Core may also, for example, comprise a private infrastructure (e.g., run by the network 100 implementer, owner, etc.). The Backbone/Core may, for example, provide any of a variety of Backbone Services (e.g., AAA, Mobility, Monitoring, Addressing, Routing, Content services, Gateway Control services, etc.).

The Backbone/Core Infrastructure may comprise any of a variety of characteristics, non-limiting examples of which are provided herein. For example, the Backbone/Core may be compatible with different wireless or wired technologies for backbone access. The Backbone/Core may also be adaptable to handle public (e.g., municipal, city, campus, etc.) and/or private (e.g., ports, campus, etc.) network infrastructures owned by different local providers, and/or owned by the network implementer or stakeholder. The Backbone/Core may, for example, comprise and/or interface with different Authentication, Authorization, and Accounting (AAA) mechanisms.

The Backbone/Core Infrastructure may, for example, support different modes of operation (e.g., L2 in port implementations, L3 in on-land public transportation implementations, utilizing any one or more of a plurality of different layers of digital IP networking, any combinations thereof, equivalents thereof, etc.) or addressing pools. The Backbone/Core may also for example, be agnostic to the Cloud provider(s) and/or Internet Service Provider(s). Additionally for example, the Backbone/Core may be agnostic to requests coming from any or all subsystems of the network 100 (e.g., Mobile APs or OBUs (On Board Units), Fixed APs or RSUs (Road Side Units), MCs (Mobility Controllers) or LMAs (Local Mobility Anchors) or Network Controllers, etc.) and/or third-party systems.

The Backbone/Core Infrastructure may, for example, comprise the ability to utilize and/or interface with different data storage/processing systems (e.g., MongoDB, MySql, Redis, etc.). The Backbone/Core Infrastructure may further, for example, provide different levels of simultaneous access to the infrastructure, services, data, etc.

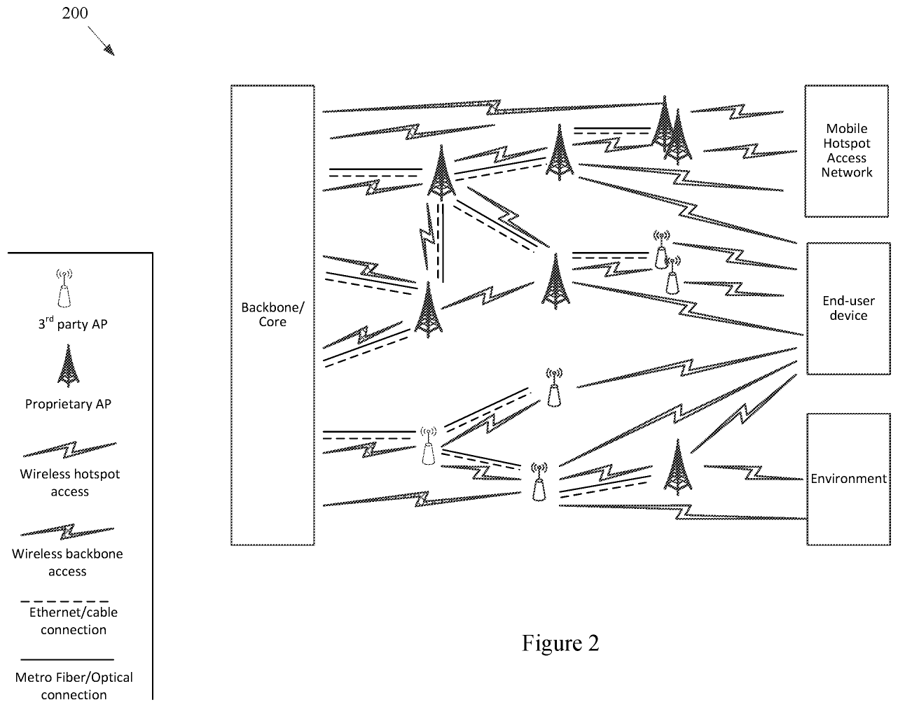

The example network 100 may also, for example, comprise a Fixed Hotspot Access Network. Various example characteristics of such a Fixed Hotspot Access Network 200 are shown at FIG. 2. The example network 200 may, for example, share any or all characteristics with the other example networks and/or network components 100, 300, 400, 500-570, and 600, discussed herein.

In the example network 200, the Fixed APs (e.g., the proprietary APs, the public third party APs, the private third party APs, etc.) may be directly connected to the local infrastructure provider and/or to the wireline/wireless backbone. Also for example, the example network 200 may comprise a mesh between the various APs via wireless technologies. Note, however, that various wired technologies may also be utilized depending on the implementation. As shown, different fixed hotspot access networks can be connected to a same backbone provider, but may also be connected to different respective backbone providers. In an example implementation utilizing wireless technology for backbone access, such an implementation may be relatively fault tolerant. For example, a Fixed AP may utilize wireless communications to the backbone network (e.g., cellular, 3G, LTE, other wide or metropolitan area networks, etc.) if the backhaul infrastructure is down. Also for example, such an implementation may provide for relatively easy installation (e.g., a Fixed AP with no cable power source that can be placed virtually anywhere).

In the example network 200, the same Fixed AP can simultaneously provide access to multiple Fixed APs, Mobile APs (e.g., vehicle OBUs, etc.), devices, user devices, sensors, things, etc. For example, a plurality of mobile hotspot access networks (e.g., OBU-based networks, etc.) may utilize the same Fixed AP. Also for example, the same Fixed AP can provide a plurality of simultaneous accesses to another single unit (e.g., another Fixed AP, Mobile AP, device, etc.), for example utilizing different channels, different radios, etc.).

Note that a plurality of Fixed APs may be utilized for fault-tolerance/fail-recovery purposes. In an example implementation, a Fixed AP and its fail-over AP may both be normally operational (e.g., in a same switch). Also for example, one or more Fixed APs may be placed in the network at various locations in an inactive or monitoring mode, and ready to become operational when needed (e.g., in response to a fault, in response to an emergency services need, in response to a data surge, etc.).

Referring back to FIG. 1, the example Fixed Hotspot Access Network is shown with a wireless communication link to a backbone provider (e.g., to one or more Backbone Providers and/or Local Infrastructure Providers), to a Mobile Hotspot Access Network, to one or more End User Devices, and to the Environment. Also, the example Fixed Hotspot Access Network is shown with a wired communication link to one or more Backbone Providers, to the Mobile Hotspot Access Network, to one or more End User Devices, and to the Environment. The Environment may comprise any of a variety of devices (e.g., in-vehicle networks, devices, and sensors; autonomous vehicle networks, devices, and sensors; maritime (or watercraft) and port networks, devices, and sensors; general controlled-space networks, devices, and sensors; residential networks, devices, and sensors; disaster recovery & emergency networks, devices, and sensors; military and aircraft networks, devices, and sensors; smart city networks, devices, and sensors; event (or venue) networks, devices, and sensors; underwater and underground networks, devices, and sensors; agricultural networks, devices, and sensors; tunnel (auto, subway, train, etc.) networks, devices, and sensors; parking networks, devices, and sensors; security and surveillance networks, devices, and sensors; shipping equipment and container networks, devices, and sensors; environmental control or monitoring networks, devices, and sensors; municipal networks, devices, and sensors; waste management networks, devices, and sensors, road maintenance networks, devices, and sensors, traffic management networks, devices, and sensors; advertising networks, devices and sensors; etc.).

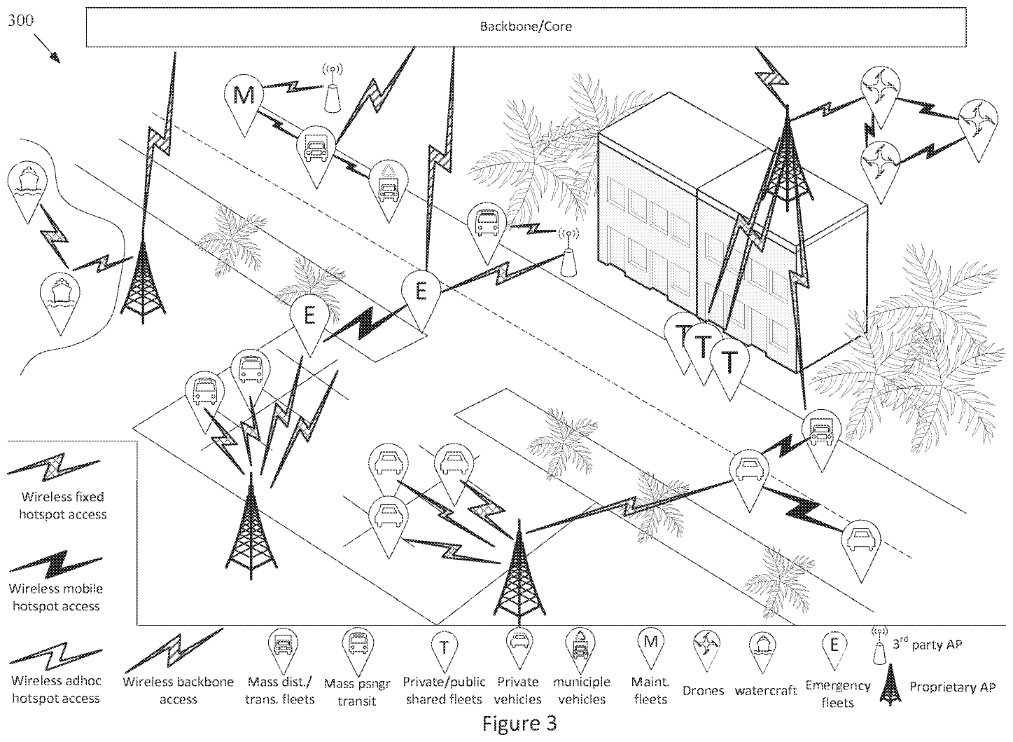

The example network 100 of FIG. 1 also comprises a Mobile Hotspot Access Network. Various example characteristics of such a Mobile Hotspot Access Network 300 are shown at FIG. 3. Note that various fixed network components (e.g., Fixed APs) are also illustrated. The example network 300 may, for example, share any or all characteristics with the other example networks and/or network components 100, 200, 400, 500-570, and 600 discussed herein.

The example network 300 comprises a wide variety of Mobile APs (or hotspots) that provide access to user devices, provide for sensor data collection, provide multi-hop connectivity to other Mobile APs, etc. For example, the example network 300 comprises vehicles from different fleets (e.g., aerial, terrestrial, underground, (under)water, etc.). For example, the example network 300 comprises one or more mass distribution/transportation fleets, one or more mass passenger transportation fleets, private/public shared-user fleets, private vehicles, urban and municipal fleets, maintenance fleets, drones, watercraft (e.g., boats, ships, speedboats, tugboats, barges, etc.), emergency fleets (e.g., police, ambulance, firefighter, etc.), etc.

The example network 300, for example, shows vehicles from different fleets directly connected and/or mesh connected, for example using same or different communication technologies. The example network 300 also shows fleets simultaneously connected to different Fixed APs, which may or may not belong to different respective local infrastructure providers. As a fault-tolerance mechanism, the example network 300 may for example comprise the utilization of long-range wireless communication network (e.g., cellular, 3G, 4G, LTE, etc.) in vehicles if the local network infrastructure is down or otherwise unavailable. A same vehicle (e.g., Mobile AP or OBU) can simultaneously provide access to multiple vehicles, devices, things, etc., for example using a same communication technology (e.g., shared channels and/or different respective channels thereof) and/or using a different respective communication technology for each. Also for example, a same vehicle can provide multiple accesses to another vehicle, device, thing, etc., for example using a same communication technology (e.g., shared channels and/or different respective channels thereof, and/or using a different communication technology).

Additionally, multiple network elements may be connected together to provide for fault-tolerance or fail recovery, increased throughput, or to achieve any or a variety of a client's networking needs, many of examples of which are provided herein. For example, two Mobile APs (or OBUs) may be installed in a same vehicle, etc.

Referring back to FIG. 1, the example Mobile Hotspot Access Network is shown with a wireless communication link to a backbone provider (e.g., to one or more Backbone Providers and/or Local Infrastructure Providers), to a Fixed Hotspot Access Network, to one or more End User Device, and to the Environment (e.g., to any one of more of the sensors or systems discussed herein, any other device or machine, etc.). Though the Mobile Hotspot Access Network is not shown having a wired link to the various other components, there may (at least at times) be such a wired link, at least temporarily.

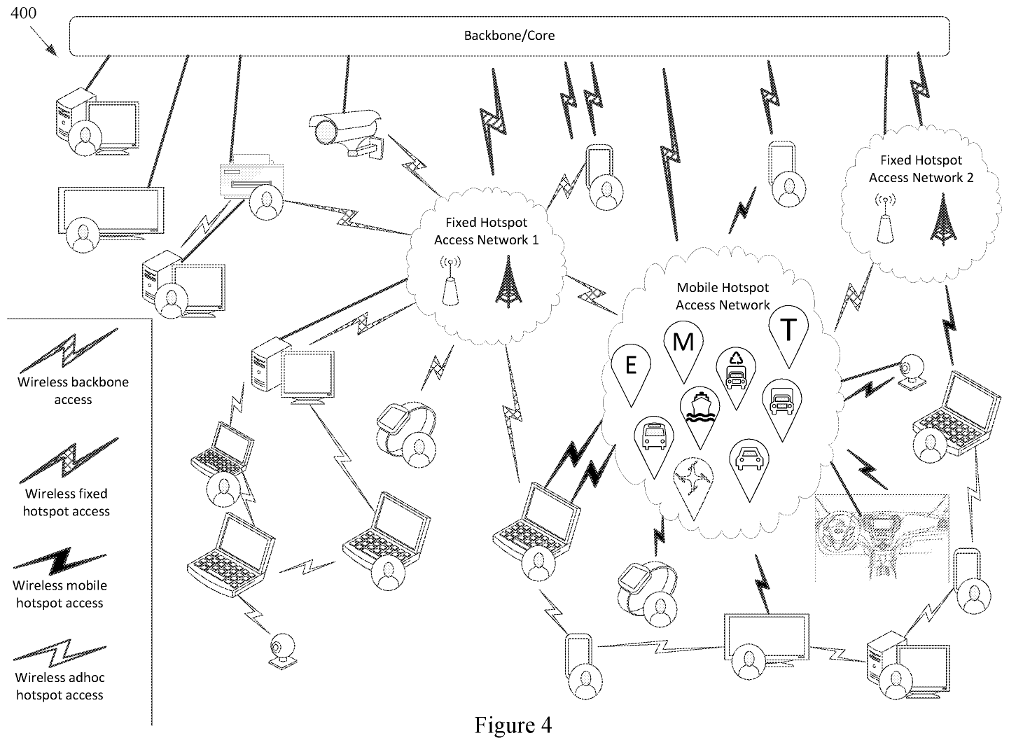

The example network 100 of FIG. 1 also comprises a set of End-User Devices. Various example end user devices are shown at FIG. 4. Note that various other network components (e.g., Fixed Hotspot Access Networks, Mobile Hotspot Access Network(s), the Backbone/Core, etc.) are also illustrated. The example network 400 may, for example, share any or all characteristics with the other example networks and/or network components 100, 200, 300, 500-570, and 600, discussed herein.

The example network 400 shows various mobile networked devices. Such network devices may comprise end-user devices (e.g., smartphones, tablets, smartwatches, laptop computers, webcams, personal gaming devices, personal navigation devices, personal media devices, personal cameras, health-monitoring devices, personal location devices, monitoring panels, printers, etc.). Such networked devices may also comprise any of a variety of devices operating in the general environment, where such devices might not for example be associated with a particular user (e.g. any or all of the sensor devices discussed herein, vehicle sensors, municipal sensors, fleet sensors road sensors, environmental sensors, security sensors, traffic sensors, waste sensors, meteorological sensors, any of a variety of different types of municipal or enterprise equipment, etc.). Any of such networked devices can be flexibly connected to distinct backbone, fixed hotspot access networks, mobile hotspot access networks, etc., using the same or different wired/wireless technologies.

A mobile device may, for example, operate as an AP to provide simultaneous access to multiple devices/things, which may then form ad hoc networks, interconnecting devices ultimately connected to distinct backbone networks, fixed hotspot, and/or mobile hotspot access networks. Devices (e.g., any or all of the devices or network nodes discussed herein) may, for example, have redundant technologies to access distinct backbone, fixed hotspot, and/or mobile hotspot access networks, for example for fault-tolerance and/or load-balancing purposes (e.g., utilizing multiple SIM cards, etc.). A device may also, for example, simultaneously access distinct backbone, fixed hotspot access networks, and/or mobile hotspot access networks, belonging to the same provider or to different respective providers. Additionally for example, a device can provide multiple accesses to another device/thing (e.g., via different channels, radios, etc.).

Referring back to FIG. 1, the example End-User Devices are shown with a wireless communication link to a backbone provider (e.g., to one or more Backbone Providers and/or Local Infrastructure Providers), to a Fixed Hotspot Access Network, to a Mobile Hotspot Access Network, and to the Environment. Also for example, the example End-User Devices are shown with a wired communication link to a backbone provider, to a Fixed Hotspot Access Network, to a Mobile Hotspot Access Network, and to the Environment.

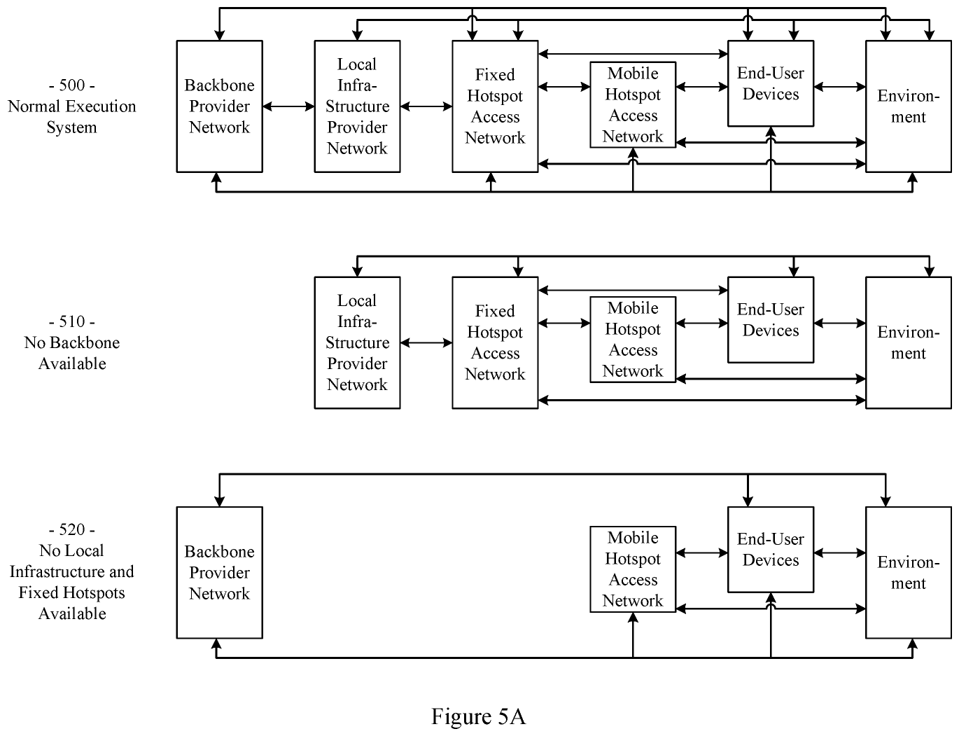

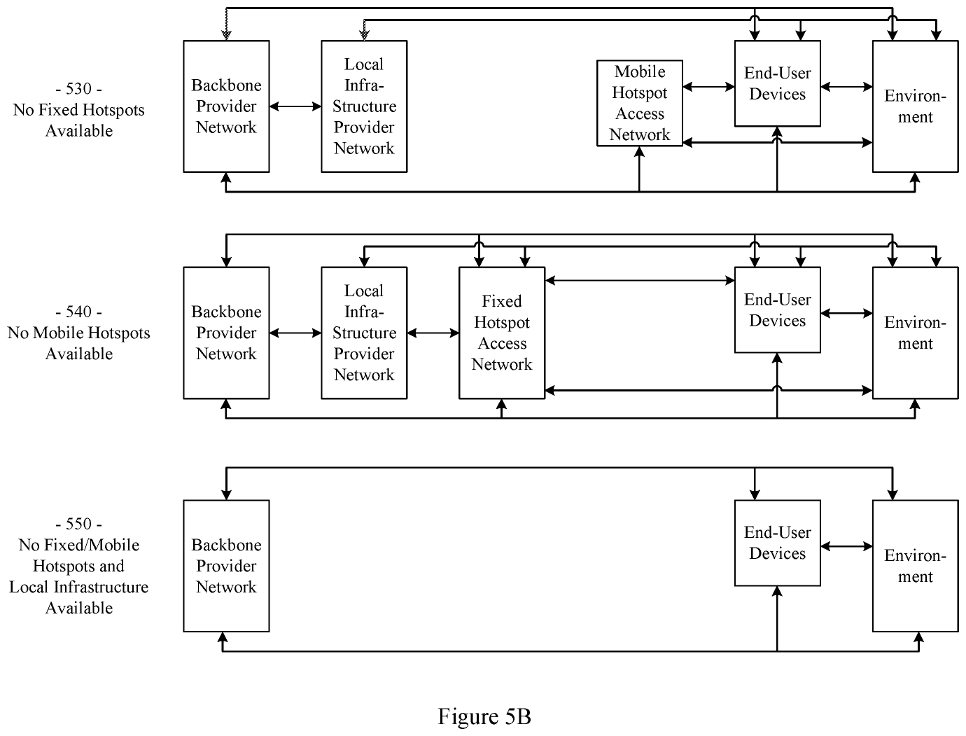

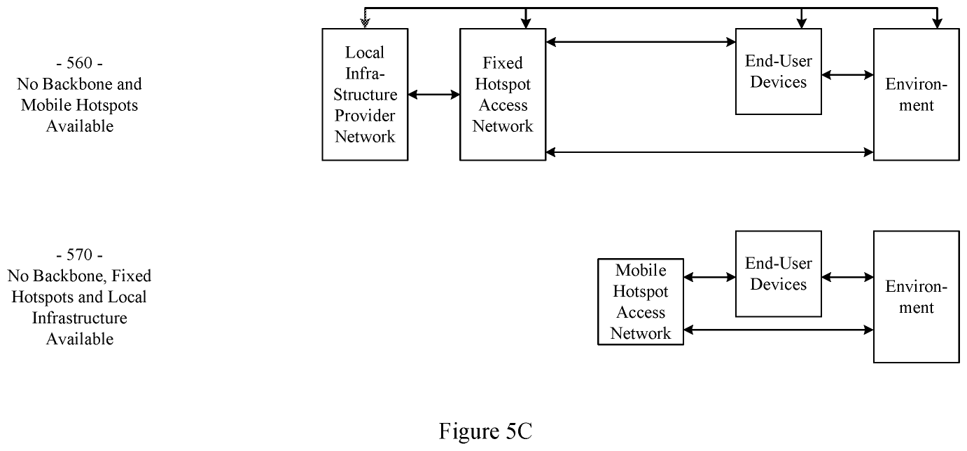

The example network 100 illustrated in FIG. 1 has a flexible architecture that is adaptable at implementation time (e.g., for different use cases) and/or adaptable in real-time, for example as network components enter and leave service. FIGS. 5A-5C illustrate such flexibility by providing example modes (or configurations). The example networks 500-570 may, for example, share any or all characteristics with the other example networks and/or network components 100, 200, 300, 400, and 600, discussed herein. For example and without limitation, any or all of the communication links (e.g., wired links, wireless links, etc.) shown in the example networks 500-570 are generally analogous to similarly positioned communication links shown in the example network 100 of FIG. 1.

For example, various aspects of this disclosure provide communication network architectures, systems, and methods for supporting a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to yield any of a variety of system goals (e.g., increased throughput, reduced latency and packet loss, increased availability and robustness of the system, extra redundancy, increased responsiveness, increased security in the transmission of data and/or control packets, reduced number of configuration changes by incorporating smart thresholds (e.g., change of technology, change of certificate, change of IP, etc.), providing connectivity in dead zones or zones with difficult access, reducing the costs for maintenance and accessing the equipment for updating/upgrading, etc.). At least some of such modalities may, for example, be entirely comprised of fixed-position nodes, at least temporarily if not permanently.

For illustrative simplicity, many of the example aspects shown in the example system or network 100 of FIG. 1 (and other Figures herein) are omitted from FIGS. 5A-5C, but may be present. For example, the Cloud, Internet, and ISP aspects shown in FIG. 1 and in other Figures are not explicitly shown in FIGS. 5A-5C, but may be present in any of the example configurations (e.g., as part of the backbone provider network or coupled thereto, as part of the local infrastructure provider network or coupled thereto, etc.).

For example, the first example mode 500 is presented as a normal execution mode, for example a mode (or configuration) in which all of the components discussed herein are present. For example, the communication system in the first example mode 500 comprises a backbone provider network, a local infrastructure provider network, a fixed hotspot access network, a mobile hotspot access network, end-user devices, and environment devices.

As shown in FIG. 5A, and in FIG. 1 in more detail, the backbone provider network may be communicatively coupled to any or all of the other elements present in the first example mode 500 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via a wired link. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the first example mode 500 (or configuration) via one or more wireless links (e.g., RF link, non-tethered optical link, etc.). For example, the backbone provider network may be communicatively coupled to the fixed hotspot access network (or any component thereof), the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

Though not shown in the first example mode 500 (or any of the example modes of FIGS. 5A-5C), one or more servers may be communicatively coupled to the backbone provider network and/or the local infrastructure network. FIG. 1 provides an example of cloud servers being communicatively coupled to the backbone provider network via the Internet.

As additionally shown in FIG. 5A, and in FIG. 1 in more detail, the local infrastructure provider network may be communicatively coupled to any or all of the other elements present in the first example mode 500 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the first example mode 500 (or configuration) via one or more wireless links (e.g., RF link, non-tethered optical link, etc.). For example, the local infrastructure provider network may be communicatively coupled to the backbone provider network (or any component thereof), the fixed hotspot access network (or any component thereof), the mobile hotspot access network (or any component thereof), the end-user devices, and/or environment devices via one or more wireless links. Note that the communication link shown in the first example mode 500 of FIG. 5A between the local infrastructure provider network and the fixed hotspot access network may be wired and/or wireless.

The fixed hotspot access network is also shown in the first example mode 500 to be communicatively coupled to the mobile hotspot access network, the end-user devices, and/or environment devices via one or more wireless links. Many examples of such wireless coupling are provided herein. Additionally, the mobile hotspot access network is further shown in the first example mode 500 to be communicatively coupled to the end-user devices and/or environment devices via one or more wireless links. Many examples of such wireless coupling are provided herein. Further, the end-user devices are also shown in the first example mode 500 to be communicatively coupled to the environment devices via one or more wireless links. Many examples of such wireless coupling are provided herein. Note that in various example implementations any of such wireless links may instead (or in addition) comprise a wired (or tethered) link.

In the first example mode 500 (e.g., the normal mode), information (or data) may be communicated between an end-user device and a server (e.g., a computer system) via the mobile hotspot access network, the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network, the local infrastructure provider network, and/or the backbone provider network (e.g., skipping the mobile hotspot access network). Also for example, information communicated between an end user device and a server may be communicated via the backbone provider network (e.g., skipping the mobile hotspot access network, fixed hotspot access network, and/or local infrastructure provider network).

Similarly, in the first example mode 500 (e.g., the normal mode), information (or data) may be communicated between an environment device and a server via the mobile hotspot access network, the fixed hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network, the local infrastructure provider network, and/or the backbone provider network (e.g., skipping the mobile hotspot access network). Also for example, information communicated between an environment device and a server may be communicated via the backbone provider network (e.g., skipping the mobile hotspot access network, fixed hotspot access network, and/or local infrastructure provider network). Additionally for example, information communicated between an environment device and a server may be communicated via the local infrastructure provider network (e.g., skipping the mobile hotspot access network and/or fixed hotspot access network).

As discussed herein, the example networks presented herein are adaptively configurable to operate in any of a variety of different modes (or configurations). Such adaptive configuration may occur at initial installation and/or during subsequent controlled network evolution (e.g., adding or removing any or all of the network components discussed herein, expanding or removing network capacity, adding or removing coverage areas, adding or removing services, etc.). Such adaptive configuration may also occur in real-time, for example in response to real-time changes in network conditions (e.g., networks or components thereof being available or not based on vehicle or user-device movement, network or component failure, network or component replacement or augmentation activity, network overloading, etc.). The following example modes are presented to illustrate characteristics of various modes in which a communication system may operate in accordance with various aspects of the present disclosure. The following example modes will generally be discussed in relation to the first example mode 500 (e.g., the normal execution mode). Note that such example modes are merely illustrative and not limiting.

The second example mode (or configuration) 510 (e.g., a no backbone available mode) may, for example, share any or all characteristics with the first example mode 500, albeit without the backbone provider network and communication links therewith. For example, the communication system in the second example mode 510 comprises a local infrastructure provider network, a fixed hotspot access network, a mobile hotspot access network, end-user devices, and environment devices.

As shown in FIG. 5A, and in FIG. 1 in more detail, the local infrastructure provider network may be communicatively coupled to any or all of the other elements present in the second example mode 510 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the second example mode 510 (or configuration) via one or more wireless links (e.g., RF link, non-tethered optical link, etc.). For example, the local infrastructure provider network may be communicatively coupled to the fixed hotspot access network (or any component thereof), the mobile hotspot access network (or any component thereof), the end-user devices, and/or environment devices via one or more wireless links. Note that the communication link(s) shown in the second example mode 510 of FIG. 5A between the local infrastructure provider network and the fixed hotspot access network may be wired and/or wireless.

The fixed hotspot access network is also shown in the second example mode 510 to be communicatively coupled to the mobile hotspot access network, the end-user devices, and/or environment devices via one or more wireless links. Many examples of such wireless coupling are provided herein. Additionally, the mobile hotspot access network is further shown in the second example mode 510 to be communicatively coupled to the end-user devices and/or environment devices via one or more wireless links. Many examples of such wireless coupling are provided herein. Further, the end-user devices are also shown in the second example mode 510 to be communicatively coupled to the environment devices via one or more wireless links. Many examples of such wireless coupling are provided herein. Note that in various example implementations any of such wireless links may instead (or in addition) comprise a wired (or tethered) link.

In the second example mode 510 (e.g., the no backbone available mode), information (or data) may be communicated between an end-user device and a server (e.g., a computer, etc.) via the mobile hotspot access network, the fixed hotspot access network, and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network and/or the local infrastructure provider network (e.g., skipping the mobile hotspot access network). Also for example, information communicated between an end user device and a server may be communicated via the local infrastructure provider network (e.g., skipping the mobile hotspot access network and/or fixed hotspot access network).

Similarly, in the second example mode 510 (e.g., the no backbone available mode), information (or data) may be communicated between an environment device and a server via the mobile hotspot access network, the fixed hotspot access network, and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network and/or the local infrastructure provider network (e.g., skipping the mobile hotspot access network). Also for example, information communicated between an environment device and a server may be communicated via the local infrastructure provider network (e.g., skipping the mobile hotspot access network and/or fixed hotspot access network).

The second example mode 510 may be utilized for any of a variety of reasons, non-limiting examples of which are provided herein. For example, due to security and/or privacy goals, the second example mode 510 may be utilized so that communication access to the public Cloud systems, the Internet in general, etc., is not allowed. For example, all network control and management functions may be within the local infrastructure provider network (e.g., wired local network, etc.) and/or the fixed access point network.

In an example implementation, the communication system might be totally owned, operated and/or controlled by a local port authority. No extra expenses associated with cellular connections need be spent. For example, cellular connection capability (e.g., in Mobile APs, Fixed APs, end user devices, environment devices, etc.) need not be provided. Note also that the second example mode 510 may be utilized in a scenario in which the backbone provider network is normally available but is currently unavailable (e.g., due to server failure, due to communication link failure, due to power outage, due to a temporary denial of service, etc.).

The third example mode (or configuration) 520 (e.g., a no local infrastructure and fixed hotspots available mode) may, for example, share any or all characteristics with the first example mode 500, albeit without the local infrastructure provider network, the fixed hotspot access network, and communication links therewith. For example, the communication system in the third example mode 520 comprises a backbone provider network, a mobile hotspot access network, end-user devices, and environment devices.

As shown in FIG. 5A, and in FIG. 1 in more detail, the backbone provider network may be communicatively coupled to any or all of the other elements present in the third example mode 520 (or configuration) via one or more wired (or tethered) links. For example, the backbone provider network may be communicatively coupled to the end-user devices and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the third example mode 520 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links.

The mobile hotspot access network is further shown in the third example mode 520 to be communicatively coupled to the end-user devices and/or environment devices via one or more wireless links. Many examples of such wireless coupling are provided herein. Further, the end-user devices are also shown in the third example mode 520 to be communicatively coupled to the environment devices via one or more wireless links. Many examples of such wireless coupling are provided herein. Note that in various example implementations any of such wireless links may instead (or in addition) comprise a wired (or tethered) link.

In the third example mode 520 (e.g., the no local infrastructure and fixed hotspots available mode), information (or data) may be communicated between an end-user device and a server (e.g., a computer, etc.) via the mobile hotspot access network and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the backbone provider network (e.g., skipping the mobile hotspot access network).

Similarly, in the third example mode 520 (e.g., the no local infrastructure and fixed hotspots available mode), information (or data) may be communicated between an environment device and a server via the mobile hotspot access network and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the backbone provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the backbone provider network (e.g., skipping the mobile hotspot access network).

In the third example mode 520, all control/management functions may for example be implemented within the Cloud. For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The third example mode 520 may be utilized for any of a variety of reasons, non-limiting examples of which are provided herein. In an example implementation, the third example mode 520 may be utilized in an early stage of a larger deployment, for example deployment that will grow into another mode (e.g., the example first mode 500, example fourth mode 530, etc.) as more communication system equipment is installed. Note also that the third example mode 520 may be utilized in a scenario in which the local infrastructure provider network and fixed hotspot access network are normally available but are currently unavailable (e.g., due to equipment failure, due to communication link failure, due to power outage, due to a temporary denial of service, etc.).

The fourth example mode (or configuration) 530 (e.g., a no fixed hotspots available mode) may, for example, share any or all characteristics with the first example mode 500, albeit without the fixed hotspot access network and communication links therewith. For example, the communication system in the fourth example mode 530 comprises a backbone provider network, a local infrastructure provider network, a mobile hotspot access network, end-user devices, and environment devices.

As shown in FIG. 5B, and in FIG. 1 in more detail, the backbone provider network may be communicatively coupled to any or all of the other elements present in the fourth example mode 530 (or configuration) via one or more wired (or tethered) links. For example, the backbone provider network may be communicatively coupled to the local infrastructure provider network (or any component thereof), the end-user devices, and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5B, and in FIG. 1 in more detail, the backbone provider network may be communicatively coupled to any or all of the other elements present in the fourth example mode 530 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fourth example mode 530 (or configuration) via one or more wired (or tethered) links. For example, the local infrastructure provider network may be communicatively coupled to the backbone provider network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fourth example mode 530 (or configuration) via one or more wireless links (e.g., RF link, non-tethered optical link, etc.). For example, the local infrastructure provider network may be communicatively coupled to the backbone provider network (or any component thereof), the mobile hotspot access network (or any component thereof), the end-user devices, and/or environment devices via one or more wireless links.

The mobile hotspot access network is further shown in the fourth example mode 530 to be communicatively coupled to the end-user devices and/or environment devices via one or more wireless links. Many examples of such wireless coupling are provided herein. Further, the end-user devices are also shown in the fourth example mode 530 to be communicatively coupled to the environment devices via one or more wireless links. Many examples of such wireless coupling are provided herein.

In the fourth example mode 530 (e.g., the no fixed hotspots mode), information (or data) may be communicated between an end-user device and a server via the mobile hotspot access network, the local infrastructure provider network, and/or the backbone provider network.

As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network and/or the backbone provider network (e.g., skipping the mobile hotspot access network). Also for example, information communicated between an end user device and a server may be communicated via the backbone provider network (e.g., skipping the mobile hotspot access network and/or local infrastructure provider network).

Similarly, in the fourth example mode 530 (e.g., the no fixed hotspots available mode), information (or data) may be communicated between an environment device and a server via the mobile hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the mobile hotspot access network). Also for example, information communicated between an environment device and a server may be communicated via the backbone provider network (e.g., skipping the mobile hotspot access network and/or local infrastructure provider network). Additionally for example, information communicated between an environment device and a server may be communicated via the local infrastructure provider network (e.g., skipping the mobile hotspot access network and/or backbone provider network).

In the fourth example mode 530, in an example implementation, some of the control/management functions may for example be implemented within the local backbone provider network (e.g., within a client premises). For example, communication to the local infrastructure provider may be performed through the backbone provider network (or Cloud). Note that in a scenario in which there is a direct communication pathway between the local infrastructure provider network and the mobile hotspot access network, such communication pathway may be utilized.

For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The fourth example mode 530 may be utilized for any of a variety of reasons, non-limiting examples of which are provided herein. In an example implementation, the fourth example mode 530 may be utilized in an early stage of a larger deployment, for example a deployment that will grow into another mode (e.g., the example first mode 500, etc.) as more communication system equipment is installed. The fourth example mode 530 may, for example, be utilized in a scenario in which there is no fiber (or other) connection available for Fixed APs (e.g., in a maritime scenario, in a plantation scenario, etc.), or in which a Fixed AP is difficult to access or connect. For example, one or more Mobile APs of the mobile hotspot access network may be used as gateways to reach the Cloud. The fourth example mode 530 may also, for example, be utilized when a vehicle fleet and/or the Mobile APs associated therewith are owned by a first entity and the Fixed APs are owned by another entity, and there is no present agreement for communication between the Mobile APs and the Fixed APs. Note also that the fourth example mode 530 may be utilized in a scenario in which the fixed hotspot access network is normally available but are currently unavailable (e.g., due to equipment failure, due to communication link failure, due to power outage, due to a temporary denial of service, etc.).

The fifth example mode (or configuration) 540 (e.g., a no mobile hotspots available mode) may, for example, share any or all characteristics with the first example mode 500, albeit without the mobile hotspot access network and communication links therewith. For example, the communication system in the fifth example mode 540 comprises a backbone provider network, a local infrastructure provider network, a fixed hotspot access network, end-user devices, and environment devices.

As shown in FIG. 5B, and in FIG. 1 in more detail, the backbone provider network may be communicatively coupled to any or all of the other elements present in the fifth example mode 540 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via one or more wired links. Note that such a wired coupling may be temporary.

Also shown in FIG. 5B, and in FIG. 1 in more detail, the backbone provider network may be communicatively coupled to any or all of the other elements present in the fifth example mode 540 (or configuration) via one or more wireless links (e.g., RF link, non-tethered optical link, etc.). For example, the backbone provider network may be communicatively coupled to the fixed hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fifth example mode 540 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fifth example mode 540 (or configuration) via one or more wireless links (e.g., RF link, non-tethered optical link, etc.). For example, the local infrastructure provider network may be communicatively coupled to the backbone provider network, the fixed hotspot access network (or any component thereof), the end-user devices, and/or environment devices via one or more wireless links. Note that the communication link(s) shown in the fifth example mode 540 of FIG. 5B between the local infrastructure provider network and the fixed hotspot access network may be wired and/or wireless.

The fixed hotspot access network is also shown in the fifth example mode 540 to be communicatively coupled to the end-user devices and/or environment devices via one or more wireless links. Many examples of such wireless coupling are provided herein. Further, the end-user devices are also shown in the fifth example mode 540 to be communicatively coupled to the environment devices via one or more wireless links. Many examples of such wireless coupling are provided herein.

In the fifth example mode 540 (e.g., the no mobile hotspots available mode), information (or data) may be communicated between an end-user device and a server via the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network, and/or the backbone provider network (e.g., skipping the fixed hotspot access network). Also for example, information communicated between an end user device and a server may be communicated via the backbone provider network (e.g., skipping the fixed hotspot access network and/or local infrastructure provider network).

Similarly, in the fifth example mode 540 (e.g., the no mobile hotspots available mode), information (or data) may be communicated between an environment device and a server via the fixed hotspot access network, the local infrastructure provider network, and/or the backbone provider network. Also for example, an environment device may communicate with or through an end-user device (e.g., instead of or in addition to the fixed hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the fixed hotspot access network). Also for example, information communicated between an environment device and a server may be communicated via the backbone provider network (e.g., skipping the fixed hotspot access network and/or local infrastructure provider network). Additionally for example, information communicated between an environment device and a server may be communicated via the local infrastructure provider network (e.g., skipping the fixed hotspot access network and/or the backbone provider network).

In the fifth example mode 540, in an example implementation, the end-user devices and environment devices may communicate directly to Fixed APs (e.g., utilizing Ethernet, Wi-Fi, etc.). Also for example, the end-user devices and/or environment devices may communicate directly with the backbone provider network (e.g., utilizing cellular connections, etc.).

The fifth example mode 540 may be utilized for any of a variety of reasons, non-limiting examples of which are provided herein. In an example implementation in which end-user devices and/or environment devices may communicate directly with Fixed APs, such communication may be utilized instead of Mobile AP communication. For example, the fixed hotspot access network might provide coverage for all desired areas.

Note also that the fifth example mode 540 may be utilized in a scenario in which the fixed hotspot access network is normally available but is currently unavailable (e.g., due to equipment failure, due to communication link failure, due to power outage, due to a temporary denial of service, etc.).

The sixth example mode (or configuration) 550 (e.g., the no fixed/mobile hotspots and local infrastructure available mode) may, for example, share any or all characteristics with the first example mode 500, albeit without the local infrastructure provider network, fixed hotspot access network, mobile hotspot access network, and communication links therewith. For example, the communication system in the sixth example mode 550 comprises a backbone provider network, end-user devices, and environment devices.

As shown in FIG. 5B, and in FIG. 1 in more detail, the backbone provider network may be communicatively coupled to any or all of the other elements present in the sixth example mode 550 (or configuration) via one or more wired (or tethered) links. For example, the backbone provider network may be communicatively coupled to the end-user devices and/or environment devices via one or more wired links. Note that such a wired coupling may be temporary.

Also shown in FIG. 5B, and in FIG. 1 in more detail, the backbone provider network may be communicatively coupled to any or all of the other elements present in the sixth example mode 550 (or configuration) via one or more wireless links (e.g., RF link, non-tethered optical link, etc.). For example, the backbone provider network may be communicatively coupled to the end-user devices and/or environment devices via one or more wireless links.

The end-user devices are also shown in the sixth example mode 550 to be communicatively coupled to the environment devices via one or more wireless links. Many examples of such wireless coupling are provided herein.

In the sixth example mode 550 (e.g., the no fixed/mobile hotspots and local infrastructure available mode), information (or data) may be communicated between an end-user device and a server via the backbone provider network. Similarly, in the sixth example mode 550 (e.g., the no fixed/mobile hotspots and local infrastructure mode), information (or data) may be communicated between an environment device and a server via the backbone provider network. Also for example, an environment device may communicate with or through an end-user device (e.g., instead of or in addition to the mobile hotspot access network).

The sixth example mode 550 may be utilized for any of a variety of reasons, non-limiting examples of which are provided herein. In an example implementation, for example in which an end-user has not yet subscribed to the communication system, the end-user device may subscribe to the system through a Cloud application and by communicating directly with the backbone provider network (e.g., via cellular link, etc.). The sixth example mode 550 may also, for example, be utilized in rural areas in which Mobile AP presence is sparse, Fixed AP installation is difficult or impractical, etc.

Note also that the sixth example mode 550 may be utilized in a scenario in which the infrastructure provider network, fixed hotspot access network, and/or mobile hotspot access network are normally available but are currently unavailable (e.g., due to equipment failure, due to communication link failure, due to power outage, due to a temporary denial of service, etc.).

The seventh example mode (or configuration) 560 (e.g., the no backbone and mobile hotspots available mode) may, for example, share any or all characteristics with the first example mode 500, albeit without the backbone provider network, mobile hotspot access network, and communication links therewith. For example, the communication system in the seventh example mode 560 comprises a local infrastructure provider network, fixed hotspot access network, end-user devices, and environment devices.

As shown in FIG. 5C, and in FIG. 1 in more detail, the local infrastructure provider network may be communicatively coupled to any or all of the other elements present in the seventh example mode 560 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary.

Also, though not explicitly shown, the local infrastructure provider network may be communicatively coupled to any or all of the other elements present in the seventh example mode 560 (or configuration) via one or more wireless links (e.g., RF link, non-tethered optical link, etc.). For example, the local infrastructure provider network may be communicatively coupled to the fixed hotspot access network (or any component thereof), the end-user devices, and/or environment devices via one or more wireless links. Note that the communication link shown in the seventh example mode 560 of FIG. 5C between the local infrastructure provider network and the fixed hotspot access network may be wired and/or wireless.

The fixed hotspot access network is also shown in the seventh example mode 560 to be communicatively coupled to the end-user devices and/or environment devices via one or more wireless links. Many examples of such wireless coupling are provided herein. Additionally, the end-user devices are also shown in the seventh example mode 560 to be communicatively coupled to the environment devices via one or more wireless links. Many examples of such wireless coupling are provided herein.

In the seventh example mode 560 (e.g., the no backbone and mobile hotspots available mode), information (or data) may be communicated between an end-user device and a server via the fixed hotspot access network and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network (e.g., skipping the fixed hotspot access network).

Similarly, in the seventh example mode 560 (e.g., the no backbone and mobile hotspots available mode), information (or data) may be communicated between an environment device and a server via the fixed hotspot access network and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the local infrastructure provider network (e.g., skipping the fixed hotspot access network).

The seventh example mode 560 may be utilized for any of a variety of reasons, non-limiting examples of which are provided herein. In an example controlled space implementation, Cloud access might not be provided (e.g., for security reasons, privacy reasons, etc.), and full (or sufficient) coverage of the coverage area is provided by the fixed hotspot access network, and thus the mobile hotspot access network is not needed. For example, the end-user devices and environment devices may communicate directly (e.g., via Ethernet, Wi-Fi, etc.) with the Fixed APs

Note also that the seventh example mode 560 may be utilized in a scenario in which the backbone provider network and/or fixed hotspot access network are normally available but are currently unavailable (e.g., due to equipment failure, due to communication link failure, due to power outage, due to a temporary denial of service, etc.).

The eighth example mode (or configuration) 570 (e.g., the no backbone, fixed hotspots, and local infrastructure available mode) may, for example, share any or all characteristics with the first example mode 500, albeit without the backbone provider network, local infrastructure provider network, fixed hotspot access network, and communication links therewith. For example, the communication system in the eighth example mode 570 comprises a mobile hotspot access network, end-user devices, and environment devices.

As shown in FIG. 5C, and in FIG. 1 in more detail, the mobile hotspot access network is shown in the eighth example mode 570 to be communicatively coupled to the end-user devices and/or environment devices via one or more wireless links. Many examples of such wireless coupling are provided herein. Further, the end-user devices are also shown in the eighth example mode 570 to be communicatively coupled to the environment devices via one or more wireless links. Many examples of such wireless coupling are provided herein.

In the eighth example mode 570 (e.g., the no backbone, fixed hotspots, and local infrastructure available mode), information (or data) might not (at least currently) be communicated between an end-user device and a server (e.g., a coupled to the backbone provider network, local infrastructure provider network, etc.). Similarly, information (or data) might not (at least currently) be communicated between an environment device and a server (e.g., a coupled to the backbone provider network, local infrastructure provider network, etc.). Note that the environment device may communicate with or through an end-user device (e.g., instead of or in addition to the mobile hotspot access network).

The eighth example mode 570 may be utilized for any of a variety of reasons, non-limiting examples of which are provided herein. In an example implementation, the eighth example mode 570 may be utilized for gathering and/or serving data (e.g., in a delay-tolerant networking scenario), providing peer-to-peer communication through the mobile hotspot access network (e.g., between clients of a single Mobile AP, between clients of respective different Mobile APs, etc.), etc. In another example scenario, the eighth example mode 570 may be utilized in a scenario in which vehicle-to-vehicle communications are prioritized above vehicle-to-infrastructure communications. In yet another example scenario, the eighth example mode 570 may be utilized in a scenario in which all infrastructure access is lost (e.g., in tunnels, parking garages, etc.).

Note also that the eighth example mode 570 may be utilized in a scenario in which the backbone provider network, local infrastructure provider network, and/or fixed hotspot access network are normally available but are currently unavailable (e.g., due to equipment failure, due to communication link failure, due to power outage, due to a temporary denial of service, etc.).

As shown and discussed herein, it is beneficial to have a generic platform that allows multi-mode communications of multiple users or machines within different environments, using multiple devices with multiple technologies, connected to multiple moving/static things with multiple technologies, forming wireless (mesh) hotspot networks over different environments, connected to multiple wired/wireless infrastructure/network backbone providers, ultimately connected to the Internet, Cloud or private network infrastructure.

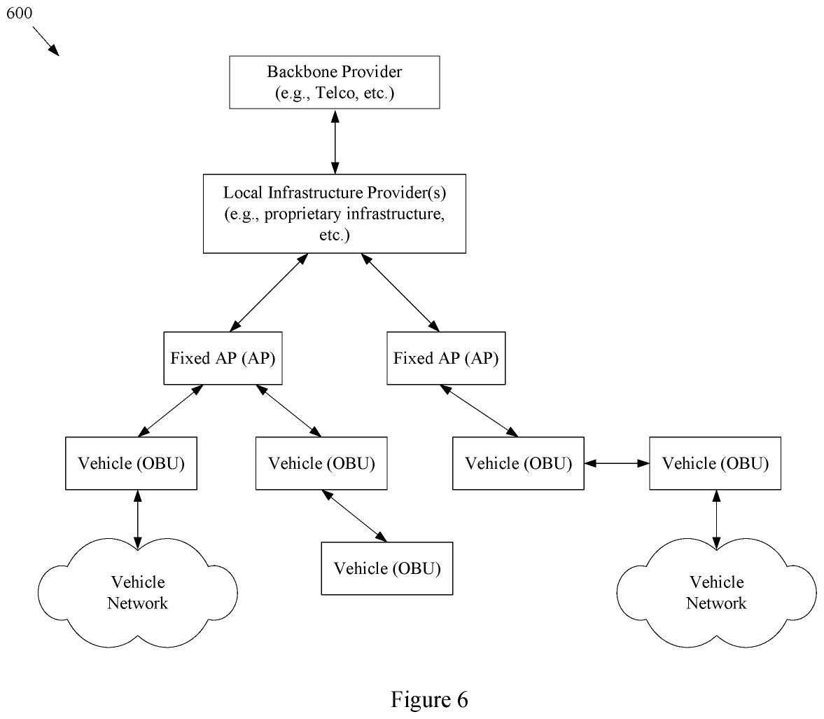

FIG. 6 shows yet another block diagram of an example network configuration, in accordance with various aspects of the present disclosure. The example network 600 may, for example, share any or all characteristics with the other example networks and/or network components 100, 200, 300, 400, and 500-570, discussed herein. Notably, the example network 600 shows a plurality of Mobile APs (or OBUs), each communicatively coupled to a Fixed AP (or RSU), where each Mobile AP may provide network access to a vehicle network (e.g., comprising other vehicles or vehicle networks, user devices, sensor devices, etc.).

In accordance with various aspects of the present disclosure, systems and methods are provided that manage a vehicle communication network, for example in accordance with the location of network nodes and end-user devices, in a way that provides for stable TCP/IP Internet access, among other things. In accordance with various aspects of the present disclosure, a vehicle may include, by way of example and not limitation, any of an automobile, taxi, van, bus, train, autonomous (e.g., self-driving/navigating) vehicle, etc. For example, an end-user may be provided with a clean and stable Wi-Fi Internet connection that may appear to the end-user to be the same as the Wi-Fi Internet connection at the end-user's home, end-user's workplace, fixed public Wi-Fi hotspots, etc. For example, for an end-user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and end-users around them, etc.).

In accordance with an example network implementation, although an end-user might be always connected to a single Wi-Fi AP of a vehicle, the vehicle (or the access point thereof, for example an on-board unit (OBU) may move between multiple access points (e.g., fixed APs, other mobile APs, cellular base stations, fixed Wi-Fi hotspots, etc.). For example, mobility management implemented in accordance with various aspects of the present disclosure supports the mobility of each vehicle and its users across different communication technologies (e.g., IEEE 802.11p, cellular, Wi-Fi (e.g., IEEE 802.11a/b/g/n/ac/af), etc.) as the mobile APs migrate among fixed APs (and/or other mobile APs) and/or as end-users migrate between mobile APs.

In accordance with various aspects of the present disclosure, a network controller (NC), which may also be referred to as a “mobility controller,” may monitor the location (e.g., network location, geographic location, etc.) of various network nodes (e.g., mobile APs, etc.) and/or the location of end-users connected through them. The network controller (NC) may, for example, provide seamless handovers (e.g., maintaining communication session continuity) between different access points (APs) and/or different technologies with low link latency and low handover times. Handover times for a “vertical handover” (i.e., between different communication technologies such as, for example, between DSRC (e.g., IEEE 802.11p), 4G Long Term Evolution (LTE), and/or Wi-Fi (e.g., IEEE 802.11a/b/g/n/ac/af)) have been observed in a range of nearly zero to times measured in milliseconds, because the new air interface of the next access point may be prepared in advance. In such a case, handover delay may be just the time for a message to go from the Mobile AP to the NC. In the case of a “horizontal handover,” the handover time may depend on the communication technology in use (e.g., DSRC 1-20 ms, Wi-Fi 0.1-5 s, and for 4G LTE it may depend upon an Internet service provider architecture) and upon the backbone providing access to the NC (e.g., from 1 to 5 ms). Link latency may be quite difficult to estimate, but have been observed in a range of 1-5 ms for DSRC (e.g., IEEE 802.11p), 10-40 ms for Wi-Fi (e.g., IEEE 802.11a/b/g/n/ac/af), and 50-500 ms for 4G LTE.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling (e.g., the use of “IP tunnels”), for example both in backend servers and in APs (e.g., fixed APs and/or mobile APs). The term “tunneling” is used herein to generally refer to the transport of another network protocol by encapsulation of its packets (e.g., including addressing information of its source and destination networks) within another packet format native to the transporting network.

Additionally, a communication network (or components thereof) in accordance with various aspects of this disclosure may comprise the ability to interact with mobile devices in order to control some or all of their connection choices and/or to leverage their control functionality. For example, in an example implementation, a mobile application may run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client. For example, the communication network (or components thereof) may comprise the capability to support different Layer 2 (L2) or Layer 3 (L3) implementations, as well as IPv4/IPv6 traffic.

FIG. 7 shows still another block diagram of an example communication network 700, in accordance with various aspects of the present disclosure. The example network 700 may, for example, share any or all characteristics with the other example methods, networks, and/or network components 100, 200, 300, 400, 500-570, 600, 800, 900, 1000, 1100, 1200, and 1300 discussed herein.

The example network 700 comprises a plurality of vehicles including buses and taxis, each equipped with mobile APs (e.g., OBUs), each communicatively coupled to a fixed AP (or RSU) (e.g., AP 1, AP 2, AP Y) or mobile AP of a neighboring vehicle. Each mobile AP may provide network access to a vehicle network (e.g., comprising other vehicles or vehicle networks, end-user devices, sensor devices, etc.). A vehicle network may, for example, include a respective Wi-Fi (e.g., IEEE 802.11a/b/g/n/ac/af) network to which end-user devices may connect, with which communication with sensors (e.g., Sensors 1-7) may be performed, etc. The mobile APs of the vehicles may, for example, move in and out of communication range of various sensors (e.g., Sensors 1-7). The mobile APs may, for example when in-range of such sensors, gather information from such sensors in a power-efficient and network-efficient manner, many examples of which are provided herein.

The example network 700 also comprises a Cloud (e.g., including one or more APIs (e.g., Cloud APIs), etc.), a plurality of Mobile Controllers (e.g., NCs NC 1, NC 2, NC 3) that may also be referred to herein as LMAs, a plurality of fixed APs (e.g., FAPs AP 1, AP 2, AP Y) that may also be referred to herein as RSUs, and a plurality of mobile APs (MAPs) that may also be referred to herein as OBUs.

A Cloud Mobility Backend (CMB) made up of one or more NCs may, for example, match network controllers (e.g., any of NC 1, NC 2, or NC 3) to MAPs of various vehicles. For example, the CMB may perform a context-aware determination of the current best NC for a particular MAP. Various non-limiting examples of system components and/or methods are provided in U.S. Provisional Application No. 62/273,715, filed Dec. 31, 2015, and titled “Systems and Methods for Managing Mobility Controllers and Their Network Interactions in a Network of Moving Things,” the entire contents of which are hereby incorporated herein by reference.

In accordance with various aspects of the present disclosure, the NC may, for example, comprise a network entity that manages a group of MAPs that are assigned to it. In an example implementation, when the NC receives a network location update from a MAP, the NC may update the procedures utilized by mobility services, for example the NC may update routes and/or tunnels utilized to forward the data traffic of the MAPs (or that of end-users connected to one or more MAPs) to the updated network location. Although the example network 700 of FIG. 7 shows three NCs (NC 1, NC 2, NC 3), any number of NCs may be utilized.

Note that although the NC is generally presented herein by example as an entity in the network backbone (or back-end), the NC may be implemented in any of a variety of network locations (or types of network nodes). For example, an NC (or a portion thereof) may be implemented in a single AP (e.g., in a fixed AP, etc.). Also for example, NC functionality may be distributed among a plurality of APs (e.g., in a plurality of fixed APs, etc.). In an AP-based implementation, the management of the position of the mobile APs in the network (e.g., CMB functionality, etc.) may be performed by the fixed APs, which share the information between them using specific control messages that identify the mobile AP (or the mobile AP assigned to each user), its point of connection, its current serving NC, and the registration timeout, etc. One or several of the fixed APs may also, for example, operate as proxies to allow the mobile APs to connect through external networks (e.g., cellular, etc.). In an example implementation in which the NC or a portion thereof is implemented in a fixed AP, scalability and redundancy may be enhanced, latency may be reduced, etc.

The fixed AP (FAP) may, for example, comprise a network entity that operates as a bridge between the wired backbone and the wireless environment. The FAP may, for example, forward traffic between the NCs and the MAPs that are within the FAP's wireless coverage area.

The FAP may, for example, be deployed in a same network as an NC. The FAP may also, for example, be deployed in a different (or foreign) network, in which case the FAP may connect to an MC through a secure VPN connection. The FAP may further, for example, connect to an MC through another FAP (e.g., utilizing a wireless link to the other FAP).

The Mobile AP (MAP) may, for example, be installed in a vehicle or other moving object. The example network 700 is shown with four example vehicles, but any number of vehicles (and therefore OBUs/MAPs) may be present. The MAP may, for example, communicate with the backbone network (or back-end network) utilizing any one or more of a plurality of communication technologies including, by way of example and not limitation, a Wi-Fi network (e.g., IEEE 802.11a/b/g/n/ac/af), a cellular network, and/or a DSRC (e.g., IEEE 802.11p) network. When the MAP switches communication technology (e.g., wireless interface technology) or access point (e.g., FAP), the MAP may inform its assigned NC about the new mobility context of the MAP (e.g., network location, geographic location, connectivity (e.g., neighboring FAPs/MAPs), etc.). Each MAP may, for example, comprise one or more local Wi-Fi APs through which the users (or clients) of the MAP can connect and through which the MAP can communicate with sensors and/or other devices, etc.

During operation, an MAP may, for example, search for the best available access point with which to connect. The MAP may identify the best available AP (e.g., a FAP, another MAP, an access point or base station of another network different from the base network (e.g., cellular), etc.) based on any of a variety of criteria (e.g., signal strength, geographic or network location, vehicle velocity, hop count, loading (e.g., number of current users), quality-of-service (QoS), quality of user experience (QoE), etc.). Such a search may, for example, be performed by a connection manager of the MAP.

If the MAP selects a fixed AP (FAP) for connection, the selecting MAP may connect to the selected FAP and send a control message to the NC to which the selecting MAP is assigned, where the control message comprises mobility context information (e.g., the identification of the selecting MAP, the identification of the FAP to which the selecting MAP is now connected, the geographic location of the selecting MAP and/or the selected FAP, etc.).

If the MAP selects another mobile AP (MAP) for connection, the selecting MAP may connect to the selected mobile AP and send a control message to the NC to which the selecting MAP is assigned, where the control message comprises mobility context information (e.g., the identification of the selecting MAP, the identification of the fixed AP that is the root of the multi-hop connection via the selected MAP, the identification of the selected MAP, the geographic location of the selecting MAP and/or the selected MAP, etc.). This message may, for example, be relayed through the multiple nodes that compose the multi-hop chain until the message arrives at the appropriate FAP, which then forwards the message to the NC.

If there is no available AP (or no available AP that meets various requirements), the MAP may connect through a cellular link with a cellular base station and send a control message to the NC to which the MAP is assigned, where the message comprises mobility context information (e.g., the identification of the MAP, its cellular control IP information, the geographic location of the MAP, etc.). Note that in a dynamic network in accordance with various aspects of the present disclosure, a mobile AP may change the AP to which it is connected often (e.g., more than once per second, more than once per ten seconds, etc.).

The NC, upon receiving and validating the control message may, for example, register the MAP in an internal database (if the MAP is not yet present in the internal database) and may update the required routes and/or tunnels and/or addresses to the MAP in order to forward the traffic of the MAP and traffic of the clients of the MAP, respectively, to the updated network location. Note that in accordance with various aspects of the present disclosure, the control messages (or at least payload portions thereof) may be encrypted, for example by exchanging key information between the NC and the MAP.

Note that if a MAP does not receive a valid response (e.g., from the NC and/or other network entity) within a particular time, the MAP may retry (e.g., retry connecting to a same or different node).

In an example scenario in which the end user changes to a new MAP (or FAP), the new MAP (or FAP) may inform the NC so that the NC knows the new network location of the end user. The NC may, for example after receiving this information from the MAP, share it with the other available NCs so that the end-user location gets updated in all of the available NCs.

As discussed herein, in accordance with various aspects of this disclosure, mobility support is provided by one or more Network Controllers (NCs), which are generally responsible for maintaining communication pathways with the Mobile APs and their connected end users, for example ensuring that all of the Mobile APs and client users thereof are reachable in the network. The NCs are, for example, generally responsible for ensuring session continuity for data traffic (e.g., for YouTube™ Skype™, media presentation services, navigation services, etc.). The NCs may, for example, be responsible for forwarding (or routing) data traffic (e.g., Internet traffic, virtual LAN traffic, virtual private network traffic, etc.) for the Mobile APs and their end users, while the Mobile APs may be continually connecting to different Fixed/Mobile APs, cellular base stations, etc. In an example implementation, the Mobile AP and NC maintain an IP tunnel between them, which is updated when the Mobile AP changes (or hands off) between Fixed/Mobile APs and/or switches between different communication technologies.

The handover (or handoff) is generally a process followed when the Mobile AP changes its point of attachment to the network (e.g., with another Mobile AP, Fixed AP, cellular base station, Wi-Fi hotspot, satellite, etc.) to maintain the connectivity and/or reachability of the Mobile AP in the network. Since handovers take time, which may result in at least small temporary interruptions in service, reducing handover time is desirable. For example, in the context of highly dynamic networks (e.g., vehicular networks, smart city networks, networks of autonomous vehicles, etc.) in which handovers occur regularly, reducing the impact of the handover is particularly desirable. For example, delays and service interruptions are immediately noticeable by the users of such networks when the end users are engaged in interactive and/or real-time applications, as are the effects of lost packets.

The handover process should ideally be as quick as possible and without loss of packets, so the handover cannot be perceived by the user(s) connected to the Mobile APs and will not adversely impact the applications executing in various nodes of the network (e.g., end user terminal nodes, mobile AP nodes, etc.).

The handover procedure can be divided into various phases (e.g., a preparation phase and an execution phase). The preparation phase may, for example, be viewed as the operations or processing happening before the disruption (or change) in the connectivity of the Mobile AP. During this phase, the Mobile AP may for example attempt to anticipate handoff activity to accommodate an imminent (or predicted) temporary disconnection. The execution phase may, for example, be viewed as the operations or processing (e.g., message exchanging, and reconfiguring, rerouting, etc.) that occurs from the disconnection time until the Mobile AP recovers its connectivity and traffic sessions. Since the execution phase is the phase that may include a temporary disconnection of the device, it may be beneficial to perform as much handover-related activity as possible during the preparation phase, for example to reduce the time needed for the execution phase.

In general, it is preferable to initiate and complete the preparation phase soon enough, so that all of the handoff preparation activities can be concluded before the handoff is needed. The initiation of the preparation phase may, for example, depend on various periodic measurements and prediction mechanisms (e.g., attempting to predict and anticipate possible connectivity disruptions before they happen). The initiation of the preparation phase may, for example, be based at least in part on the context information available (e.g., RSSI measurements of the present connection and signals from neighboring connection points (e.g., fixed APs and/or mobile APs), available connection points and their resources, the geographic locations of network nodes, etc.).

The execution phase should be as short as possible. Additionally, in accordance with various aspects of this disclosure, various communication technologies comprise features that may be utilized, for example allowing for connectivity of a Mobile AP to a plurality of other network nodes (e.g. a present connection point and a future connection point) to smoothly transition sessions between them.

Handovers may be categorized into what are referred to herein as “horizontal handovers” and “vertical handovers.” A horizontal handover may, for example, occur when a new connection is established with another access point with the same wireless air interface or technology (e.g., between two DSRC APs), and thus a horizontal handover may also be referred to as an intra-technology reconnection. A vertical handover may, for example, occur between different interfaces or different wireless technologies (e.g., from use of a DSRC wireless air interface to a cellular wireless air interface, and vice versa). As discussed herein, a vertical handover may for example provide for maintaining (at least temporarily) connectivity with multiple networks (and/or multiple respective communication technologies), for example in the preparation phase.

Accordingly, various aspects of this disclosure provide systems and methods that collect and share the vehicular context information used to predict and prepare for both vertical and horizontal handovers. Also, various aspects of this disclosure provide systems and methods that provide for fast handover.

For example, as discussed herein, various local mobility anchor (LMA/NC) functionality may be performed by different network nodes (e.g., Network Controller nodes, Fixed AP nodes, Mobile AP nodes, cellular base station nodes, etc.). Pushing various mobility control functionality close to the Mobile AP level may, for example, provide for reduced latency in NC-to/from-MAP communication, provide for reduced latency in preparing for and/or executing handoff operations, etc.

Various aspects of this disclosure also provide systems and methods that provide for route optimization after the handover to ensure higher throughput and lower delay, for example ensuring utilization of the best routing path between the Mobile AP and its NC.

In accordance with various aspects of this disclosure, as discussed herein, the Mobile AP may comprise a plurality of wireless communication interfaces for communicating utilizing different respective communication technologies (e.g., DSRC or 802.11p, cellular, Wi-Fi, Satellite, Bluetooth, etc.). Such architecture provides flexibility that may be leveraged to provide the best wireless interface available to the mobile AP and to provide for efficient handovers between connection points utilizing different respective technologies without adversely impacting an on-going communication session.

At the other end of a communication session (e.g., via the Internet, via a virtual LAN, via a virtual private network, etc.), the other node (e.g., a YouTube™ server, a Skype™ server, a gaming server, an interactive media server, a database server, a web server, etc.) may be able to treat the mobile AP with a consistent address (e.g., a same IP address).

In an example scenario in which the Mobile AP switches from a DSRC access point (e.g., a FAP) to a cellular base station, the Mobile AP may, for example, send/receive to/from a different interface with a different IP address, but this may then be effectively hidden by the NC, for example providing for seamless operation by the other node(s) to the communication.

In another example scenario in which the Mobile AP switches from a first fixed AP (e.g., a first DSRC access point) to a second fixed AP (e.g., a second DSRC access point), the IP address of the Mobile AP may remain the same, while routing is modified by the Network Controller so that the NC can direct data to the second Fixed AP after the handoff.

As discussed herein, handovers may be categorized into horizontal and vertical handovers. In an example horizontal handover scenario, in accordance with various aspects of this disclosure, a previous AP (e.g., a fixed AP, mobile AP, etc.) may be utilized (e.g., at least temporarily) as a local mobility anchor for the handover to the next AP, for example during the handover execution. Such operation may, for example, be particularly useful when the NC cannot be located inside the client network, resulting in higher latency. In an example implementation, a temporary tunnel may be created between the previous AP and the new AP, and the information of the Mobile AP may then be routed between the previous AP and the new AP, until the NC completes the rerouting of information directly to the new AP.

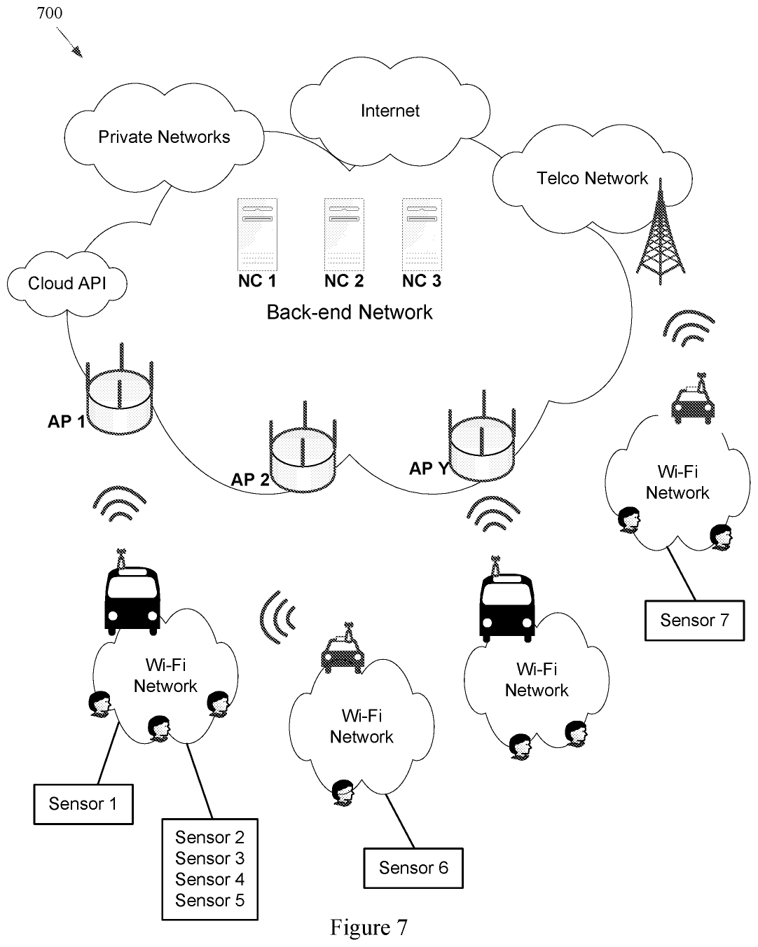

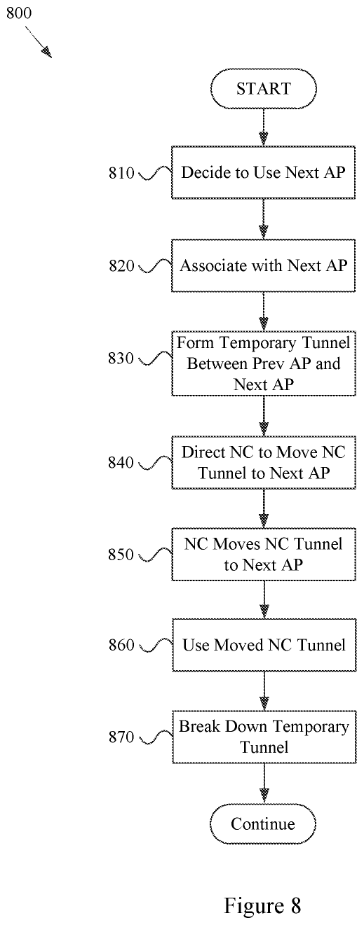

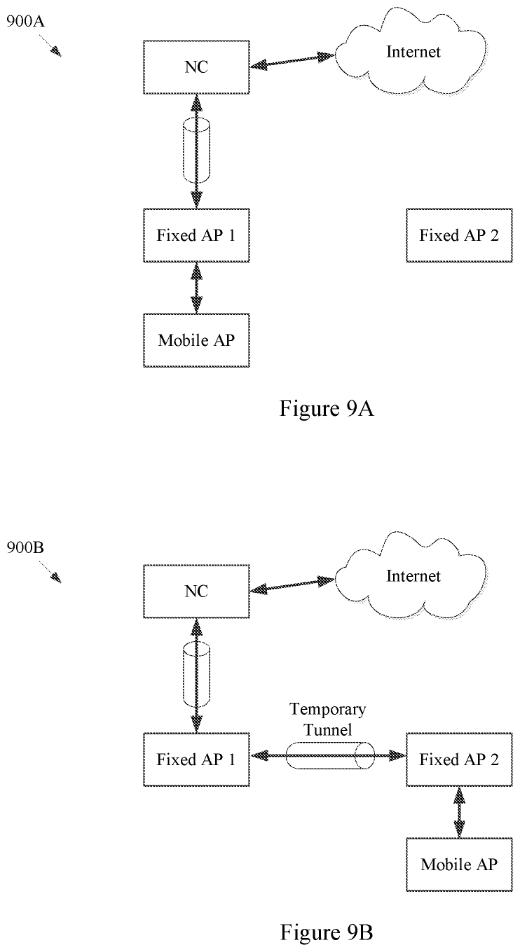

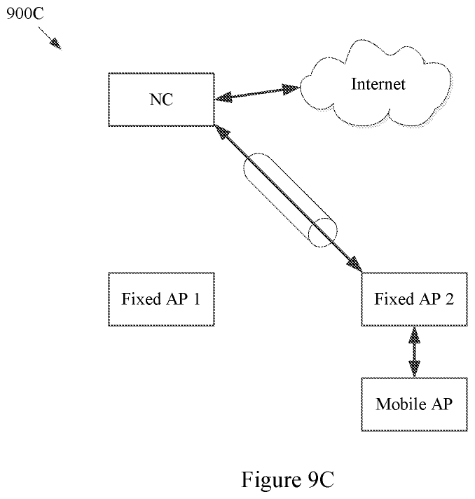

FIG. 8 shows a flow diagram of a method 800 of handing off a mobile access point (MAP), in accordance with various aspects of the present disclosure. FIGS. 9A-9C show block diagrams illustrating various aspects of the example method 800 of FIG. 8, in accordance with various aspects of the present disclosure. The example method 800 may, for example, share any or all characteristics with the other example methods and/or network or component functionality discussed herein with regard to the networks and/or network components 100, 200, 300, 400, 500-570, 600, 700, 900, 1000, 1100, 1200, and 1300 discussed herein. The discussion will now generally address FIGS. 8 and 9A-9C together.

The example method 800 may, at block 810, comprise a Mobile AP deciding to utilize a next access point (e.g., a Fixed AP, a Mobile AP, etc.) for connectivity to the communication network. The Mobile AP may decide to utilize a next access point in any of a variety of manners, non-limiting examples of which are provided herein.

For example, the Mobile AP may continually (e.g., periodically) evaluate various communication signal characteristics of its current access point and neighboring access points. For example, the Mobile AP may evaluate signal strength (e.g., RSSI) of signals received from such access points, signal-to-noise ratio (S/N), etc., and may determine to move to a next access point based at least in part on such signal characteristics. For example, the Mobile AP may determine to move to a next access point with a stronger signal than a current access point (e.g., stronger, stronger by at least a threshold margin, etc.), a better S/N ratio (e.g., higher, higher by at least a threshold margin, etc.), etc.

Also for example, the Mobile AP may monitor its location (e.g., GNSS/GPS location, etc.) and/or the respective locations of access points, and determine to move to a next access point based at least in part on such location(s). For example, the Mobile AP may determine to move to an access point that is geographically closer to it (e.g., closer, closer by at least a threshold margin, etc.) than a current access point. Also for example, the Mobile AP may determine to move to a next access point based on approaching a location that has been historically associated with a handoff.

Additionally for example, the Mobile AP may make a decision to move to a next access point based, at least in part, on present access point loads or available communication bandwidth, based at least in part on a command received from another network node, based at least in part on communication priority (e.g., emergency communications may be automatically routed through cellular), etc. Further for example, other nodes (e.g., an NC, Fixed AP, other network node, etc.) may similarly monitor link characteristics and other factors and provide information of such monitored characteristics to the Mobile AP for utilization by the Mobile AP in the handoff decision. Alternatively, another network node (e.g., an NC, Fixed AP, etc.) may make the handoff decision, and indicate this decision to the Mobile AP and/or other network nodes in a message.

In accordance with various aspects of the present disclosure, the vehicle in which the Mobile AP is installed may be, for example, an autonomous vehicle, which may travel a route determined by systems of such a vehicle using, for example, the location of a designated destination, or may follow a route provided to the autonomous vehicle that the vehicle may then travel. In either instance, information about the route being travelled may be provided to the OBU/MAP of the vehicle, for use in making handoff/handover decisions regarding, for example, selection of a next access point. In accordance with various aspects of the present disclosure, access points (e.g., fixed and/or mobile access points) may share their current geographic location (e.g., GNSS/GPS-based latitude/longitude/altitude positioning information) with neighbor access points. Knowledge of a route that is being travelled (e.g., provided to an OBU/MAP by an autonomous vehicle system or by a Cloud-based system of a network of moving things as described herein) enables an OBU/MAP to determine the whereabouts of nearby access points in relation to the route being travelled by the vehicle carrying the OBU/MAP, permitting the OBU/MAP to determine which access point to select as a next access point in performing a handoff/handover. An OBU/MAP in accordance with the present disclosure may know its own current geographic location, and may know the current locations of nearby access points (e.g., from map information for the area covered by the network (e.g., mapping locations of roads and fixed access points), which may be resident at or available to the OBU/MAP, or information shared by nearby access points with the OBU/MAP via the network, including via a Cloud-based system). In addition, an OBU/MAP may know the route travelled by the autonomous vehicle in which it is installed, and therefore the current location along the route of that vehicle. Using such information, the OBU/MAP may calculate an estimate of an amount of time until the vehicle carrying the OBU/MAP is expected to be able to communicate with nearby access points further along the travelled route, and thereby is able to anticipate which access points will be available for communication and when in time those access points will be encountered, thereby permitting the OBU/MAP to anticipate the opportunity to handoff/handover to a known next access point, and to prepare for such a handoff/handover by communicating with, for example, the known next access point, a Network Controller, and/or a Cloud-based system, to speed the handoff/handover. Timing aspects of the handoff/handover that may be improved by such anticipation include, for example, the setup of tunnels connecting a Network Controller to one or more access points, establishment of temporary tunnels between access points, and communications with networks employing other air interface standard (e.g., when handing off from DSRC to cellular or cellular to DSRC) to enable preparations for the potentially more complex and/or time consuming arrangements for such handoffs to be initiated or made.

FIG. 9A shows an example network configuration when the decision is made to perform a handoff. The Mobile AP is communicating with Fixed AP 1, which in turn is communicating through an NC tunnel with the NC, which is turn is communicating via the Internet (e.g., on behalf of the Mobile AP). At block 810, the Mobile AP may for example determine to begin utilizing Fixed AP 2 instead of Fixed AP 1.

The example method 800 may, at block 820, comprise the Mobile AP associating with the next access point. For example, as shown at FIG. 9B, after the Mobile AP determines to utilize Fixed AP 2, the Mobile AP may associate with Fixed AP 2. At this point, the Mobile AP performs its wireless network communications with Fixed AP 2. The term “association” in this context may be used to refer to a “logical” association of the Mobile AP with a Fixed AP (e.g., Fixed AP 2). In accordance with various aspects of the present disclosure, a Mobile AP wishing to associate with a particular Fixed AP may send a message to the particular Fixed AP, indicating that the Mobile AP would like to receive data traffic through the particular Fixed AP, and may indicate that the Mobile AP was previously receiving data traffic through an (identified) different Fixed AP. For example, when using DSRC (i.e., IEEE 802.11p), any given Fixed AP may maintain a list of Mobile APs that wish to receive data traffic through (i.e., have requested a “logical” association with) that Fixed AP. A “logical” association in accordance with the present disclosure may result in the establishment of a tunnel (e.g., an IP or other suitable tunnel) between a Fixed AP with which the Mobile AP was previously associated and the Fixed AP now in “logical” association with the Mobile AP, and/or between the NC and the Fixed AP now in logical association with the Mobile AP, to enable the forwarding of data traffic to the Mobile AP.

At this point (or at some other point in the example method), the Mobile AP may disassociate with Fixed AP 1. Such disassociation may also, for example, be performed at block 830 or at other blocks of the example method 800.

The example method 800 may, at block 830, comprise forming a temporary tunnel between the previous access point (e.g., the access point Fixed AP 1, from which the Mobile AP is moving) and the next access point (e.g., the access point Fixed AP 2, to which the Mobile AP moving). Such tunnel formation may be performed in any of a variety of manners.

For example, the next access point may communicate a request to the previous access point (e.g., via direct DSRC link, etc.) to establish such a tunnel. The previous access point may then confirm the formation of the tunnel, for example by communicating a return message to the next access point. At this point, communications (e.g., messages, packets, frames, etc.) arriving at the previous access point (e.g., from the NC) and destined for (e.g., addressed to) the Mobile AP may be directed by the previous access point to the next access point, which may then forward such communications to the Mobile AP. For example, referring to FIG. 9B, communications received at Fixed AP 1 from the NC and destined for the Mobile AP may be directed by Fixed AP 1 to Fixed AP 2, which may then forward such communications to the Mobile AP. FIG. 9B shows an example temporary tunnel between Fixed AP 1 and Fixed AP 2.

At this point, the NC tunnel between the NC and the previous access point (e.g., Fixed AP 1) is still maintained and utilized. If for some reason, the next access point (e.g., Fixed AP 2) cannot communicate with the previous access point (e.g., Fixed AP 1), the next access point can interact directly with the NC to update the tunnel with the NC, thus skipping the formation and utilization of the temporary tunnel.

The example method 800 may, at block 840, comprise directing the NC to move the NC tunnel from the previous access point to the next access point. For example, when the handover to the next access point is completed (at least from the perspective of the Mobile AP), the next access point may send a request message to the NC to modify the endpoint of the NC tunnel for the Mobile AP from the previous access point to the next access point. For example, referring to FIG. 9B, after the establishment of the temporary tunnel between Fixed AP 1 and Fixed AP 2, Fixed AP 2 may send a message to the NC requesting (or directing) the NC to modify the endpoint of the tunnel for the Mobile AP from Fixed AP 1 to Fixed AP 2.

The example method 800 may, at block 850, comprise the NC moving the NC tunnel for the Mobile AP from the previous access point to the next access point, thus optimizing such tunnel. An example of such NC tunnel modification is provided in the change from FIG. 9B to FIG. 9C. At this point, communications destined for the Mobile AP may flow directly from the NC to Fixed AP 2, for example as opposed to flowing from the NC to Fixed AP 1 and then from Fixed AP 1 to Fixed AP 2.

In an example implementation, the NC may reply to the next access point (e.g., to Fixed AP 2 in FIG. 9C) to confirm the success or completion of the tunnel update.

The example method 800 may, at block 860 comprise utilizing the moved NC tunnel for communications. The example method 800 may then, for example at block 870, comprise breaking down the temporary tunnel (e.g., formed at block 830). In an example implementation, upon successful modification of the endpoint of the NC tunnel for the Mobile AP from the previous access point to the next access point, the temporary tunnel between the previous access point and the next access point is no longer needed. In such case, the next access point may actively break down the temporary tunnel (e.g., by messaging the previous access point, etc.) or may passively break down the temporary tunnel (e.g., by relying on timer expiration, stale link cleanup operation, etc.).

Note that if an error occurs in the process of modifying the NC tunnel for the Mobile AP, and for example the NC tunnel is not modified, the temporary tunnel may remain active (e.g., until the Mobile AP performs another handover). Alternatively, the next access point may determine that the NC tunnel has not been modified correctly (e.g., by not receiving an expected reply message from the NC within a threshold amount of time, upon continuing to receive traffic for the Mobile AP from the previous access point (e.g., after a time threshold), etc.), and may repeat sending the request to the NC for modification of the NC tunnel endpoint to the next access point.

As discussed above, handovers may be categorized into horizontal and vertical handovers. In an example vertical handover scenario between an AP (e.g., a Fixed AP, Mobile AP, etc.) and a base station, in accordance with various aspects of this disclosure, a previous AP connection may be utilized for the communication of control messages during the handover process, for example reducing the handover time caused by the cellular network latency.

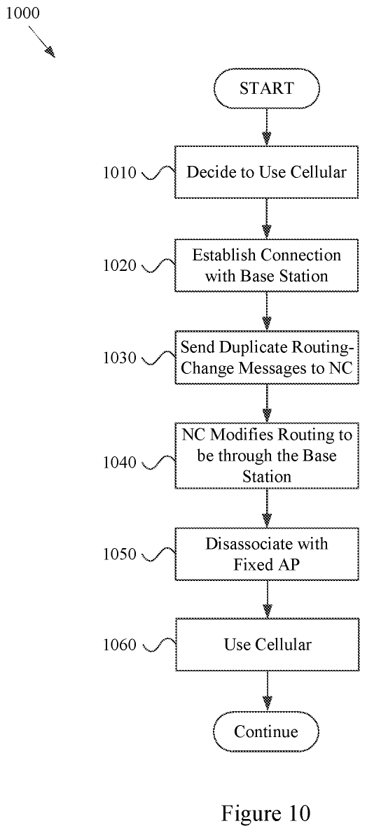

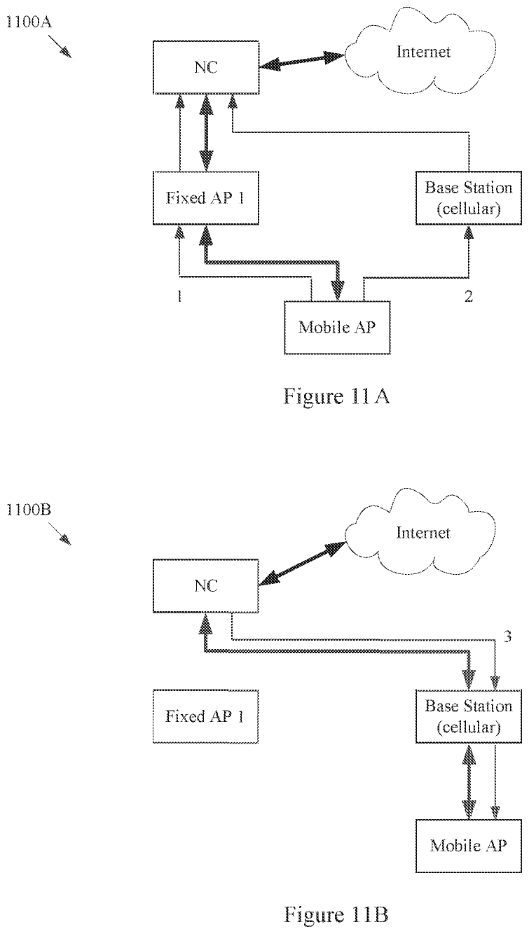

FIG. 10 shows a flow diagram of a method 1000 of handing off a mobile access point, in accordance with various aspects of the present disclosure. FIGS. 11A-11B show block diagrams illustrating various aspects of the example method 1000 of FIG. 10, in accordance with various aspects of the present disclosure. The example method 1000 may, for example, share any or all characteristics with the other example methods and/or network or component functionality discussed herein with regard to the networks and/or network components 100, 200, 300, 400, 500-570, 600, 700, 800, 900, 1100, 1200, and 1300 discussed herein. The discussion will now generally address FIGS. 10 and 11A-11B together.

The example method 1000 may, at block 1010, comprise a Mobile AP deciding to utilize a cellular base station (or other technology connection point, for example, satellite, Wi-Fi, etc.) instead of a current access point (e.g., a DSRC fixed or mobile access point, etc.). Block 1010 may, for example, share any or all characteristics with block 810 discussed herein. For example, the handoff decision may be made based on communication signal characteristics, access point or base station characteristics, load conditions, available bandwidth, power availability and/or requirements, communication quality characteristics, cost, communication priority, location(s), vehicle trajectory, handoff or performance history, one or more communications received from another network node, etc.

In an example scenario, after a period of time (e.g., several routes, several days, several weeks, etc.) operating along a same transit route, a Mobile AP (or other network node) may identify a handoff pattern, for example the Mobile AP may generally handoff to a base station at a particular location. As the vehicle carrying the Mobile AP nears the particular location (e.g., as indicated by GNSS/GPS information, as indicated by time and/or vehicle route information, as indicated by signal strength triangulation, as expected by vehicle location and trajectory information, etc.), handoff preparations may begin, for example in anticipation of the handoff. For example, such predictive handoff may be initiated by the Mobile AP and/or may be initiated by a central controller or other network node with an overall system view.

The example method 1000 may, at block 1020, comprise the Mobile AP establishing a connection or communication link with a base station. Block 1020 may, for example, comprise the Mobile AP establishing a connection (e.g., associating, attaching, joining, etc.) with the base station in any of a variety of manners, depending on the cellular protocol.

The example method 100 may, at block 1030, comprise sending duplicate messages to the NC requesting a routing change from the AP to the base station. The Mobile AP may send a first of such duplicate messages to the NC through the AP, and the Mobile AP may send a second of such duplicate messages to the NC through the base station. Note that this technique may also be extended to utilizing any of a variety of other communication paths (e.g., via a Wi-Fi hot spot, via a plurality of APs and/or base stations, via a set of best APs and/or base stations, etc.).

For example, even in a scenario in which a communication link with a current AP (e.g., Fixed AP, Mobile AP, etc.) is marginal or ineffective for substantial data communication (e.g., Internet communication, etc.), such communication link may be utilized for relatively short messages (e.g., control messages, short data packets including any one or more of measurement information, context information, node status information, error information, failure information, throughput information, signal quality information, loading information, communication link status information, congestion information, location information, power supply or utilization information, etc.). For example, at least a first signal strength level may be a minimum level appropriate (or deemed appropriate) for normal network communications, while a second signal strength level lower than the first signal strength level may be a minimum level appropriate (or deemed appropriate) for the communication of control messages (or packets) and small data messages.

The sending of the duplicate messages through at least the AP (e.g., Fixed AP, Mobile AP, etc.) and the base station ensures that the message will reach the NC as fast as possible. In an example implementation, since communication latency (or delay) through the DSRC network is generally substantially lower than communication latency through the cellular network, the version of the duplicate message sent through the DSRC network will generally, but not always, reach the NC before the version of the duplicate message sent through the cellular network. Such efficient communication may, for example, provide for completing a handoff in a few milliseconds. Additionally, the communication of such duplicate messages also helps to ensure that the message will reach the NC (e.g., even in the event that one or more of the duplicate messages is lost or corrupted).

FIG. 11A illustrates the communication of a first of the duplicate messages 1 to the NC through Fixed AP 1 and a second of the duplicate messages 2 to the NC through the Base Station. Note that the duplicate messages may be communicated as a same payload (or data structure) in different types of respective packets communicated in accordance with different respective protocols. At this point, the general data communication between the Mobile AP and the NC is still proceeding through the Fixed AP.

Note that at this point, the Mobile AP may assume that the handover will be completed successfully and begin communicating upstream information to the NC via the Base Station. Alternatively, the Mobile AP may wait for a confirmation message from the NC.

The example method 1000 may, at block 1040, comprise (e.g., in response to the NC receiving at least one of the duplicate messages sent at block 1030) the NC modifying the communication routing with the Mobile AP to utilize the base station instead of the access point. The NC may, for example, modify a routing table that indicates a forwarding destination node for messages received by the NC (e.g., from the Internet or other network) that are ultimately destined for the Mobile AP. FIG. 11B shows an example of such rerouting at the bold line that extends between the NC and the Base Station, rather than between the NC and Fixed AP 1 (e.g., as shown in FIG. 11A).

Block 1040 may also, for example, comprise the NC sending a response message to the Mobile AP, for example via the base station. The response message may, for example, verify to the Mobile AP that the NC has modified the routing from the NC to the Mobile AP to include the base station instead of the AP. Though the Mobile AP need not wait for such message from the NC to continue operating with the base station, assuming that the handoff was or would be successful (e.g., for communicating upstream messages to the NC and/or anticipating downstream messages from the NC), such message may at least indicate to the Mobile AP that the handoff was successful. For example, such message may keep the Mobile AP from sending a repeat handoff request (or directive) to the NC, for example in a scenario in which the Mobile AP does not receive messages from the base station within a threshold amount of time.

The message is shown by example in FIG. 11B as message 3. In the example provided at FIG. 11B, the NC communicates with the Mobile AP via the base station.

The example method 1000 may, at block 1050, comprise the Mobile AP disassociating with the previous AP. Such disassociation may, for example, be explicit (e.g., by sending a disassociation message, etc.), but need not be. For example, such disassociation may occur by communication timeout, etc.

Also note that the disassociation need not occur at this point in the example method 1000. For example, the Mobile AP may disassociate with the previous AP when the decision is made to associate with (or connect with) the base station, when or after the handoff request message is sent to the NC, or at various other points in the example method 1000.

The example method 1000 may, at block 1060, comprise using the base station for other communications.

Note that the example method 1000 of FIG. 10 was presented in a scenario involving a Mobile AP handing off from an AP (e.g., a DSRC Fixed AP, Mobile AP, etc.) to a base station (e.g., a cellular base station, a satellite, etc.), however, the scope of this disclosure is not limited thereto. For example, a reverse handoff (e.g., between a base station and an AP, etc.) may also be conducted in an analogous manner. For example, a Mobile AP handing off from a base station (e.g., a cellular base station, a satellite, etc.) to an AP (e.g., a DSRC Fixed AP, Mobile AP, etc.) may similarly send a handoff request (or directive) message to the NC through the base station and through the AP for handing off the Mobile AP to the Fixed AP.

In accordance with various aspects of the present disclosure, fast horizontal and vertical handovers for Mobile APs and their connected users are provided. Such handovers reduce/eliminate the periods of time during which the Mobile AP is not connected to the network/Internet (e.g., unable to exchange IP data, etc.) during a handoff.

Various aspects of the present disclosure, for example, provide for seamless handover for the users (or clients) connected to the Mobile APs in a moving environment. Such handover, for example, may give the perception to the user that they are always connected, while the Mobile AP is continually handing over between (or reconnections to) different connection points (e.g., access points, base stations, etc.) of the same or different wireless technologies. Such handover provides for the best user experience with real-time application (e.g., Skype™ VoIP applications, etc.) and also with various non-real-time applications (e.g., YouTube™, media streaming, etc.).

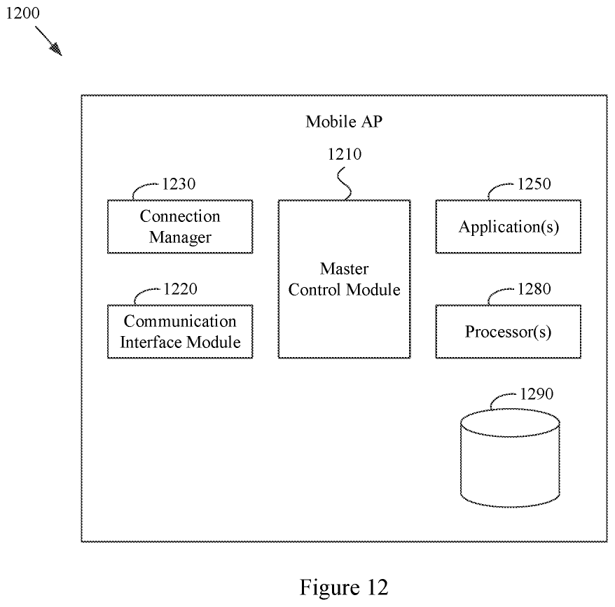

FIG. 12 shows a block diagram of various components of an example Mobile AP, in accordance with various aspects of the present disclosure. The example Mobile AP 1200 may, for example, share any or all characteristics with the other example methods, nodes, networks, and/or network components 100-1100 and 1300, discussed herein. For example, any or all of the components of the example Mobile AP 1200 may perform any or all of the method steps presented herein.

The example Mobile AP 1200 may, for example, comprise a communication interface module 1220 that operates to perform any or all of the wireless and/or wired communication functionality for the Mobile AP 1200, many examples of which are provided herein (e.g., communication with MCs, communication with fixed AP nodes, communication with mobile AP nodes, communication directly with client devices, backhaul communication, communication with a GNSS/GPS receiver, etc.). The communication I/F module 1220 may, for example, operate in accordance with any of a variety of cellular communication protocols, wireless LAN communication protocols (e.g., Wi-Fi, etc.), wireless PAN communication protocols (e.g., Bluetooth, etc.), IEEE 802.11p or DSRC, satellite communication protocols, fiber or cable communication protocols, LAN protocols (e.g., Ethernet, etc.), etc. For example, any of the example communication discussed herein between a Mobile AP and an NC, between a Mobile AP and a fixed or mobile AP, etc., may be performed utilizing the communication interface module 1220.

The example Mobile AP 1200 also comprises a Connection Manager Module 1230 that, for example, manages connections between the Mobile AP 1200 and one or more APs (e.g., Mobile APs, Fixed APs, etc.), base stations (e.g., cellular base stations, satellites, etc.), user or client devices (e.g., cellphones, smart phones, handheld/tablet/laptop personal computers, Network Controllers, etc. The Connection Manager Module 1230 may, for example, utilize communication services provided by the Communication Interface Module 1220 to perform various aspects of such communication. The Connection Manager Module 1230 may, for example, operate to perform any or all of the handoff functionality discussed herein (e.g., with regard to the example method 800 of FIG. 8, with regard to the example method 1000 of FIG. 10, etc.).

The example Mobile AP 1200 may, for example, comprise a Master Control Module 1210 that generally manages operation of the Mobile AP 1200 at a high level. Such Master Control Module 1210 may, for example, comprise various aspects of an operating system for the Mobile AP 1200.

The example Mobile AP 1200 may further, for example, comprise one or more applications 1250 executing on the Mobile AP 1200 (e.g., client management applications, security applications, power management applications, vehicle monitoring applications, location services applications, user interface applications, etc.).

The example Mobile AP 1200 may also comprise one or more processors 1280 and memory devices 1290. The processor(s) 1280 may, for example, comprise any of a variety of processor characteristics. For example, the processor(s) 1280 may comprise one or more of a general purposes processor, reduced instruction set (RIS) processor, microcontroller, application specific integrated circuit (ASIC), digital signal processor (DSP), video processor, etc.). The memory device(s) 1290 may, for example comprise any of a variety of memory characteristics. For example, the memory device(s) 1290 may comprise a volatile memory, non-volatile memory, etc. The memory device(s) 1290 may, for example, comprise a non-transitory computer-readable medium that comprises software instructions that when executed by the processor(s) 1280, cause the Mobile AP 1200 to perform any or all of the functionality discussed herein (e.g., with regard to the example methods discussed herein, etc.).

Note that the example Mobile AP 1200 may also be a Fixed AP 1200 (or base station), in which case, the modules operate to perform any or all of the functionality discussed herein with regard to fixed access points and/or base stations.

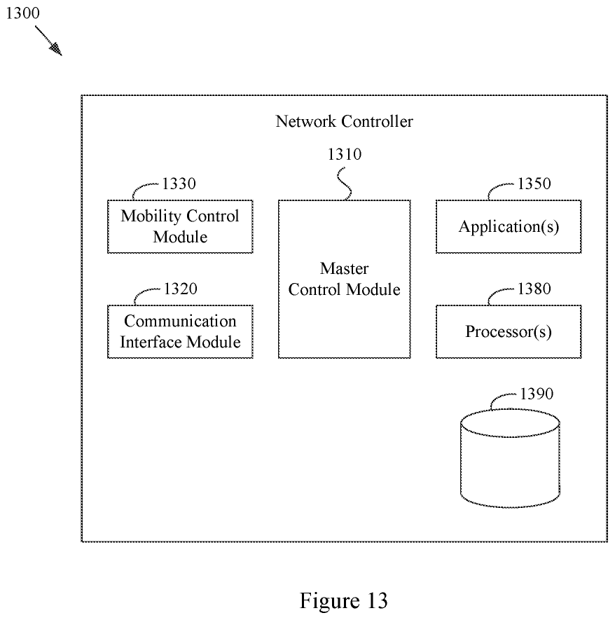

FIG. 13 shows a block diagram of various components of an example Network Controller (NC), in accordance with various aspects of the present disclosure. The example NC 1300 may, for example, share any or all characteristics with the other example methods, nodes, networks, and/or network components 100-1100 and 1200, discussed herein. For example, any or all of the components of the example Network Controller 1300 may perform any or all of the method steps presented herein.

The example NC 1300 may, for example, comprise a communication interface module 1320 that operates to perform any or all of the wireless and/or wired communication functionality for the NC 1300, many examples of which are provided herein (e.g., communication with entities upstream from the NC, communication with fixed AP nodes, communication with mobile AP nodes, communication with cellular (or other) base stations, communication with the cloud or APIs, backhaul communication, etc.). The communication I/F module 1320 may, for example, operate in accordance with any of a variety of cellular communication protocols, wireless LAN communication protocols (e.g., Wi-Fi, etc.), wireless PAN communication protocols (e.g., Bluetooth, etc.), IEEE 802.11p or DSRC, satellite communication protocols, fiber or cable communication protocols, LAN protocols (e.g., Ethernet, etc.), etc. For example, any of the example communication discussed herein between an NC and a Mobile AP, between an NC and a fixed or mobile AP, etc., may be performed utilizing the communication interface module 1320.

The example NC 1300 also comprises a Mobility Control Module 1330 that, for example, manages the mobility of the Mobile APs for which the NC 1300 is responsible, for example including communications between the NC 1300 and one or more APs (e.g., Mobile APs, Fixed AP, etc.), base stations (e.g., cellular base stations, satellites, etc.), user or client devices, central controllers, etc. The Mobility Control Module 1330 may, for example, utilize communication services provided by the Communication Interface Module 1320 to perform various aspects of such communication. The Mobility Control Module 1330 may, for example, operate to perform any or all of the handoff functionality discussed herein (e.g., with regard to the example method 800 of FIG. 8, with regard to the example method 1000 of FIG. 10, etc.).

The example NC 1300 may, for example, comprise a Master Control Module 1310 that generally manages operation of the NC 1300 at a high level. Such Master Control Module 1310 may, for example, comprise various aspects of an operating system for the NC 1300.

The example NC 1300 may further, for example, comprise one or more applications 1350 executing on the NC 1300 (e.g., client management applications, security applications, power management applications, vehicle monitoring applications, location services applications, user interface applications, etc.).

The example NC 1300 may also comprise one or more processors 1380 and memory devices 1390. The processor(s) 1380 may, for example, comprise any of a variety of processor characteristics. For example, the processor(s) 1380 may comprise one or more of a general purposes processor, RIS processor, microcontroller, ASIC, DSP, video processor, etc.). The memory device(s) 1390 may, for example comprise any of a variety of memory characteristics. For example, the memory device(s) 1390 may comprise a volatile memory, non-volatile memory, etc. The memory device(s) 1390 may, for example, comprise a non-transitory computer-readable medium that comprises software instructions that when executed by the processor(s) 1380, cause the NC 1300 to perform any or all of the functionality discussed herein (e.g., with regard to the example methods discussed herein, etc.).

In summary, various aspects of this disclosure provide systems and methods for initiating and/or managing the handoff of mobile access points. As non-limiting examples, various aspects of this disclosure provide systems and methods for control signaling and data routing in the context of a mobile access point handoff. While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

In accordance with various aspects of the present disclosure, systems and methods are provided that manage a vehicle communication network, for example in accordance with the location of nodes and end devices, in a way that provides for stable TCP/IP Internet access, among other things. For example, an end user may be provided with a clean and stable Wi-Fi Internet connection that may appear to the end user to be the same as the Wi-Fi Internet connection at the user's home, user's workplace, fixed public Wi-Fi hotspots, etc. For example, for a user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and users around them, etc.).

In accordance with an example network implementation, although a user might be always connected to a single Wi-Fi AP of a vehicle, the vehicle (or the access point thereof, for example an OBU) is moving between multiple access points (e.g., Fixed APs, other Mobile APs, cellular base stations, fixed Wi-Fi hotspots, etc.). For example, mobility management implemented in accordance with various aspects of the present disclosure supports the mobility of each vehicle and its users across different communication technologies (e.g., IEEE 802.11p, cellular, Wi-Fi, etc.) as the Mobile APs migrate among Fixed APs (and/or Mobile APs) and/or as users migrate between Mobile APs.

In accordance with various aspects of the present disclosure, a network controller (NC), which may also be referred to as an LMA or Mobility Controller, may monitor the location (e.g., network location, etc.) of various nodes (e.g., Mobile APs, etc.) and/or the location of end users connected through them. The network controller (NC) may, for example, provide seamless handovers (e.g., maintaining communication session continuity) between different access points and/or different technologies with low link latency and low handover times.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling, for example both in backend servers and in APs (e.g., Fixed APs and/or Mobile APs).

Additionally, a communication network (or components thereof) in accordance with various aspects of this disclosure may comprise the ability to interact with mobile devices in order to control some or all of their connection choices and/or to leverage their control functionality. For example, in an example implementation, a mobile application can run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client, etc. For example, the communication network (or components thereof) may comprise the capability to support different Layer 2 (L2) or Layer 3 (L3) implementations, or combinations thereof, as well as IPv4/IPv6 traffic.

Various aspects of the present disclosure may be seen in a method of managing and triggering handover of a mobile network node in a network of moving things comprising a plurality of network nodes. Such a method may comprise performing, by the mobile network node using a first wireless communication protocol, a first association with a first network node of the plurality of network nodes, wherein the first association results in creation of a first data path connecting the first network node and a remote system providing data connectivity between the first data path and a backbone network. The method may also comprise determining existence of at least one condition at the mobile network node indicative of a likelihood of loss of wireless communication of the mobile network node with the first network node, and identifying a second network node of the plurality of network nodes according to one or more characteristics of the mobile network node and one or more characteristics of the second network node. The method may comprise performing, by the mobile network node using the first wireless communication protocol, a second association with the second network node, wherein the second association results in creation of a second data path connecting the first network node and the second network node. The method may further comprise wirelessly transferring data, by the mobile network node to and from the backbone network via the second network node, the first network node, the first data path, and the remote system.

In accordance with various aspects of the present disclosure, the one or more characteristics of the mobile network node may comprise a current geographic location of the mobile network node and the one or more characteristics of the second network node may comprise a current geographic location of the second network node. The one or more characteristics of the mobile network node may comprise a velocity of a vehicle carrying the mobile network node. In addition, the one or more characteristics of the mobile network node may comprise a route being traveled by a vehicle carrying the mobile network node and the one or more characteristics of the second network node may comprise a current geographic location of the second network node. The vehicle may be an autonomous vehicle and the route being traveled may be provided to the mobile network node by a navigation system of the autonomous vehicle. The first data path may employ tunneling to enable communication between the remote system and the first network node.

In accordance with various aspects of the present disclosure, a third data path connecting the second network node and the remote system may be created in response to the second association, and the first data path and the second data path may be disconnected after creation of the third data path. The third data path may employ tunneling to enable communication between the remote system and the second network node. The first network node may be at a fixed location and the second network node may be a mobile network node. The at least one condition at the mobile network node may comprise a strength indication representative of a signal received from the first network node being below a first threshold. The remote system may monitor geographic locations of respective network nodes of the plurality of network nodes. The mobile network node may support wireless communication with end-user devices, and the remote system may monitor the geographic location of corresponding end-user devices connected through the remote system. The backbone network may comprise the Internet. The remote system may enable seamless handover of the mobile network node from wireless communication with the first network node to wireless communication with a base station of a cellular network.

Various aspects of the present disclosure may also be observed in a non-transitory computer-readable medium comprising a plurality of code sections, where each code section comprises a plurality of instructions executable by one or more processors. The plurality of instructions may cause the one or more processor to perform the steps of a method of managing and triggering handover of a mobile network node in a network of moving things comprising a plurality of network nodes, such as the example method set forth above.

Additional aspects of the present disclosure may be found in a system for performing a method of managing and triggering handover of a mobile network node in a network of moving things comprising a plurality of network nodes. Such a system may comprise one or more communication interfaces configured to wirelessly communicate with the plurality of network nodes, to communicate with a satellite-based navigation receiver, and to communicate with one or more systems of a vehicle. The system may also comprise computer-readable memory for storing one or more software applications and program data; and one or more processors operably coupled to the one or more communication interfaces and the computer-readable memory. The one or more processors may be operable to, at least, perform the steps of the example method set forth above.

In accordance with various aspects of this disclosure, examples of the networks and/or components thereof presented herein are provided in U.S. Provisional Application Ser. No. 62/222,192, titled “Communication Network of Moving Things,” filed on Sep. 22, 2015, which is hereby incorporated herein by reference in its entirety.

In accordance with various aspects of this disclosure, the networks and/or components thereof presented herein are provided with systems and methods for integrating such networks and/or components with other networks and systems, non-limiting examples of which are provided in U.S. Provisional Application Ser. No. 62/221,997, titled “Integrated Communication Network for A Network of Moving Things,” filed on Sep. 22, 2015, which is hereby incorporated herein by reference in its entirety.

Also, in accordance with various aspects of this disclosure, the networks and/or components thereof presented herein are provided with systems and methods for synchronizing such networks and/or components, non-limiting examples of which are provided in U.S. Provisional Application Ser. No. 62/222,016, titled “Systems and Methods for Synchronizing a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for managing such networks and/or components, non-limiting examples of which are provided in U.S. Provisional Application Ser. No. 62/222,042, titled “Systems and Methods for Managing a Network of Moving Things,” filed on Sep. 22, 2015, which is hereby incorporated herein by reference in its entirety.

Further, in accordance with various aspects of this disclosure, the networks and/or components thereof presented herein are provided with systems and methods for monitoring such networks and/or components, non-limiting examples of which are provided in U.S. Provisional Application Ser. No. 62/222,066, titled “Systems and Methods for Monitoring a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for detecting and/or classifying anomalies in such networks and/or components, non-limiting examples of which are provided in U.S. Provisional Application Ser. No. 62/222,077, titled “Systems and Methods for Detecting and Classifying Anomalies in a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for managing mobility in such networks and/or components, non-limiting examples of which are provided in U.S. Provisional Application Ser. No. 62/222,098, titled “Systems and Methods for Managing Mobility in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for managing connectivity in such networks and/or components, non-limiting examples of which are provided in U.S. Provisional Application Ser. No. 62/222,121, titled “Systems and Methods for Managing Connectivity a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for collecting sensor data in such networks and/or components, non-limiting examples of which are provided in U.S. Provisional Application Ser. No. 62/222,135, titled “Systems and Methods for Collecting Sensor Data in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for interfacing with such networks and/or components, non-limiting examples of which are provided in U.S. Provisional Application Ser. No. 62/222,145, titled “Systems and Methods for Interfacing with a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for interfacing with a user of such networks and/or components, non-limiting examples of which are provided in U.S. Provisional Application Ser. No. 62/222,150, titled “Systems and Methods for Interfacing with a User of a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for data storage and processing in such networks and/or components, non-limiting examples of which are provided in U.S. Provisional Application Ser. No. 62/222,168, titled “Systems and Methods for Data Storage and Processing for a Network of Moving Things,” filed on Sep. 22, 2015, which is hereby incorporated herein by reference in its entirety.

Also, in accordance with various aspects of this disclosure, the networks and/or components thereof presented herein are provided with systems and methods for vehicle traffic management in such networks and/or components, non-limiting examples of which are provided in U.S. Provisional Application Ser. No. 62/222,183, titled “Systems and Methods for Vehicle Traffic Management in a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for environmental management in such networks and/or components, non-limiting examples of which are provided in U.S. Provisional Application Ser. No. 62/222,186, titled “Systems and Methods for Environmental Management in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for managing port or shipping operation in such networks and/or components, non-limiting examples of which are provided in U.S. Provisional Application Ser. No. 62/222,190, titled “Systems and Methods for Port Management in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for enhancing the accuracy of positioning or location information based at least in part on historical data, non-limiting examples of which are provided in U.S. Provisional Application Ser. No. 62/244,828, titled “Utilizing Historical Data to Correct GPS Data in a Network of Moving Things,” filed on Oct. 22, 2015, which is hereby incorporated herein by reference in its entirety.

Additionally, in accordance with various aspects of this disclosure, the networks and/or components thereof presented herein are provided with systems and methods for enhancing the accuracy of position or location of positioning or location information based at least in part on the utilization of anchors, non-limiting examples of which are provided in U.S. Provisional Application Ser. No. 62/244,930, titled “Using Anchors to Correct GPS Data in a Network of Moving Things,” filed on Oct. 22, 2015, which is hereby incorporated herein by reference in its entirety.

Further, in accordance with various aspects of this disclosure, the networks and/or components thereof presented herein are provided with systems and methods for providing communication between applications, non-limiting examples of which are provided in U.S. Provisional Application Ser. No. 62/246,368, titled “Systems and Methods for Inter-Application Communication in a Network of Moving Things,” filed on Oct. 26, 2015, which is hereby incorporated herein by reference in its entirety.

Still further, in accordance with various aspects of this disclosure, the networks and/or components thereof presented herein are provided with systems and methods for probing, analyzing and/or validating communication, non-limiting examples of which are provided in U.S. Provisional Application Ser. No. 62/246,372, titled “Systems and Methods for Probing and Validating Communication in a Network of Moving Things,” filed on Oct. 26, 2015, which is hereby incorporated herein by reference in its entirety.

Yet further, in accordance with various aspects of this disclosure, the networks and/or components thereof presented herein are provided with systems and methods for adapting communication rate, non-limiting examples of which are provided in U.S. Provisional Application Ser. No. 62/250,544, titled “Adaptive Rate Control for Vehicular Networks,” filed on Nov. 4, 2015, which is hereby incorporated herein by reference in its entirety.

Also, in accordance with various aspects of this disclosure, the networks and/or components thereof presented herein are provided with systems and methods for reconfiguring and adapting hardware, non-limiting examples of which are provided in U.S. Provisional Application Ser. No. 62/273,878, titled “Systems and Methods for Reconfiguring and Adapting Hardware in a Network of Moving Things,” filed on Dec. 31, 2015, which is hereby incorporated herein by reference in its entirety.

Additionally, in accordance with various aspects of this disclosure, the networks and/or components thereof presented herein are provided with systems and methods for optimizing the gathering of data, non-limiting examples of which are provided in U.S. Provisional Application Ser. No. 62/253,249, titled “Systems and Methods for Optimizing Data Gathering in a Network of Moving Things,” filed on Nov. 10, 2015, which is hereby incorporated herein by reference in its entirety.

Further, in accordance with various aspects of this disclosure, the networks and/or components thereof presented herein are provided with systems and methods for performing delay tolerant networking, non-limiting examples of which are provided in U.S. Provisional Application Ser. No. 62/257,421, titled “Systems and Methods for Delay Tolerant Networking in a Network of Moving Things,” filed on Nov. 19, 2015, which is hereby incorporated herein by reference in its entirety.

Still further, in accordance with various aspects of this disclosure, the networks and/or components thereof presented herein are provided with systems and methods for improving the coverage and throughput of mobile access points, non-limiting examples of which are provided in U.S. Provisional Application Ser. No. 62/265,267, titled “Systems and Methods for Improving Coverage and Throughput of Mobile Access Points in a Network of Moving Things,” filed on Dec. 9, 2015, which is hereby incorporated herein by reference in its entirety.

Yet further, in accordance with various aspects of this disclosure, the networks and/or components thereof presented herein are provided with systems and methods for coordinating channel utilization, non-limiting examples of which are provided in U.S. Provisional Application Ser. No. 62/270,858, titled “Channel Coordination in a Network of Moving Things,” filed on Dec. 22, 2015, which is hereby incorporated herein by reference in its entirety.

Also, in accordance with various aspects of this disclosure, the networks and/or components thereof presented herein are provided with systems and methods for implementing a network coded mesh network in the network of moving things, non-limiting examples of which are provided in U.S. Provisional Application Ser. No. 62/257,854, titled “Systems and Methods for Network Coded Mesh Networking in a Network of Moving Things,” filed on Nov. 20, 2015, which is hereby incorporated herein by reference in its entirety.

Additionally, in accordance with various aspects of this disclosure, the networks and/or components thereof presented herein are provided with systems and methods for improving the coverage of fixed access points, non-limiting examples of which are provided in U.S. Provisional Application Ser. No. 62/260,749, titled “Systems and Methods for Improving Fixed Access Point Coverage in a Network of Moving Things,” filed on Nov. 30, 2015, which is hereby incorporated herein by reference in its entirety.

Further, in accordance with various aspects of this disclosure, the networks and/or components thereof presented herein are provided with systems and methods for managing mobility controllers and their network interactions, non-limiting examples of which are provided in U.S. Provisional Application Ser. No. 62/273,715, titled “Systems and Methods for Managing Mobility Controllers and Their Network Interactions in a Network of Moving Things,” filed on Dec. 31, 2015, which is hereby incorporated herein by reference in its entirety.

Still further, in accordance with various aspects of this disclosure, the networks and/or components thereof presented herein are provided with systems and methods for managing and/or triggering handovers of mobile access points, non-limiting examples of which are provided in U.S. Provisional Application Ser. No. 62/281,432, titled “Systems and Methods for Managing and Triggering Handovers of Mobile Access Points in a Network of Moving Things,” filed on Jan. 21, 2016, which is hereby incorporated herein by reference in its entirety.

Yet further, in accordance with various aspects of this disclosure, the networks and/or components thereof presented herein are provided with systems and methods for performing captive portal-related control and management, non-limiting examples of which are provided in U.S. Provisional Application Ser. No. 62/268,188, titled “Captive Portal-related Control and Management in a Network of Moving Things,” filed on Dec. 16, 2015, which is hereby incorporated herein by reference in its entirety.

Also, in accordance with various aspects of this disclosure, the networks and/or components thereof presented herein are provided with systems and methods for extrapolating high-value data, non-limiting examples of which are provided in U.S. Provisional Application Ser. No. 62/270,678, titled “Systems and Methods to Extrapolate High-Value Data from a Network of Moving Things,” filed on Dec. 22, 2015, which is hereby incorporated herein by reference in its entirety.

Additionally, in accordance with various aspects of this disclosure, the networks and/or components thereof presented herein are provided with systems and methods for providing remote software updating and distribution, non-limiting examples of which are provided in U.S. Provisional Application Ser. No. 62/272,750, titled “Systems and Methods for Remote Software Update and Distribution in a Network of Moving Things,” filed on Dec. 30, 2015, which is hereby incorporated herein by reference in its entirety.

Further, in accordance with various aspects of this disclosure, the networks and/or components thereof presented herein are provided with systems and methods for providing remote configuration updating and distribution, non-limiting examples of which are provided in U.S. Provisional Application Ser. No. 62/278,662, titled “Systems and Methods for Remote Configuration Update and Distribution in a Network of Moving Things,” filed on Jan. 14, 2016, which is hereby incorporated herein by reference in its entirety.

Still further, in accordance with various aspects of this disclosure, the networks and/or components thereof presented herein are provided with systems and methods for adapting the network, for example automatically, based on user feedback, non-limiting examples of which are provided in U.S. Provisional Application Ser. No. 62/286,243, titled “Systems and Methods for Adapting a Network of Moving Things Based on User Feedback,” filed on Jan. 22, 2016, which is hereby incorporated herein by reference in its entirety.

Yet further, in accordance with various aspects of this disclosure, the networks and/or components thereof presented herein are provided with systems and methods for enhancing and/or guaranteeing data integrity when building or performing data analytics, non-limiting examples of which are provided in U.S. Provisional Application Ser. No. 62/278,764, titled “Systems and Methods to Guarantee Data Integrity When Building Data Analytics in a Network of Moving Things,” Jan. 14, 2016, which is hereby incorporated herein by reference in its entirety.

Also, in accordance with various aspects of this disclosure, the networks and/or components thereof presented herein are provided with systems and methods for performing self-initialization and/or automated bootstrapping of mobile access points, non-limiting examples of which are provided in U.S. Provisional Application Ser. No. 62/286,515, titled “Systems and Methods for Self-Initialization and Automated Bootstrapping of Mobile Access Points in a Network of Moving Things,” filed on Jan. 25, 2016, which is hereby incorporated herein by reference in its entirety.

Additionally, in accordance with various aspects of this disclosure, the networks and/or components thereof presented herein are provided with systems and methods for managing power supply and/or utilization, non-limiting examples of which are provided in U.S. Provisional Application Ser. No. 62/295,602, titled “Systems and Methods for Power Management in a Network of Moving Things,” filed on Feb. 16, 2016, which is hereby incorporated herein by reference in its entirety.

Further, in accordance with various aspects of this disclosure, the networks and/or components thereof presented herein are provided with systems and methods for automating and easing the installation and setup of the infrastructure, non-limiting examples of which are provided in U.S. Provisional Application Ser. No. 62/299,269, titled “Systems and Methods for Automating and Easing the Installation and Setup of the Infrastructure Supporting a Network of Moving Things,” filed on Feb. 24, 2016, which is hereby incorporated herein by reference in its entirety.

In summary, various aspects of this disclosure provide communication network architectures, systems and methods for supporting a network of mobile nodes, for example comprising a combination of mobile and stationary nodes. As a non-limiting example, various aspects of this disclosure provide communication network architectures, systems, and methods for supporting a dynamically configurable communication network comprising a complex array of both static and moving communication nodes (e.g., the Internet of moving things). While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

1-30. (canceled)

31. A method of managing and triggering handover of a mobile network node in a network of moving things comprising a plurality of network nodes, the method comprising:
determining a geographic location along a route of travel of a mobile network node that the mobile network node will reach due to movement of the mobile network node, wherein the mobile network node is associated with a first network node that is connected via a first data path to a remote system;
determining, before reaching the geographical location, existence of at least one condition at the geographic location, the at least one condition indicative of a likelihood of loss of wireless communication of the mobile network node with the first network node;
in response to the determining of the existence of the at least one condition, identifying a second network node according to one or more characteristics of the mobile network node and one or more characteristics of the second network node, wherein the second network node is of a different type and supports a different type of network connectivity than the first network node;
based on determining that the mobile network node is approaching the geographic location along the route of travel and before a need for switching to the second network node arises, automatically preparing for handover of the mobile network node from the first network node to the second network node, the preparing comprising creating a temporary tunnel between the first network node and the second network node; and
after the mobile network node connects to the second network node:
forwarding data traffic communicated between the mobile network node and the remote system via the second network node, the temporary tunnel, and the first data path;
setting up a second data path connecting the second network node and the remote system; and
switching forwarding of the data traffic to the second data path.

32. The method according to claim 31, wherein the one or more characteristics of the mobile network node comprise a current geographic location of the mobile network node and the one or more characteristics of the second network node comprise a current geographic location of the second network node.

33. The method according to claim 31, wherein the one or more characteristics of the mobile network node comprises a velocity of a vehicle carrying the mobile network node.

34. The method according to claim 31, wherein the one or more characteristics of the mobile network node comprise a route being traveled by a vehicle carrying the mobile network node and the one or more characteristics of the second network node comprise a current geographic location of the second network node.

35. The method according to claim 34, wherein the vehicle is an autonomous vehicle and the route being traveled is provided to the mobile network node by a navigation system of the autonomous vehicle.

36. The method according to claim 31, further comprising identifying a pattern of handover of the mobile network node at the geographic location.

37. The method according to claim 31, wherein the first network node is at a fixed location and the second network node is a second mobile network node of the plurality of network nodes.

38. The method according to claim 31, wherein the at least one condition at the mobile network node comprises a strength indication representative of a signal received from the first network node being below a first threshold.

39. The method according to claim 31, wherein the mobile network node supports wireless communication with end-user devices, and the remote system monitors the geographic location of corresponding end-user devices connected through the remote system.

40. The method according to claim 31, wherein the remote system enables seamless handover of the mobile network node from wireless communication with the first network node to wireless communication with the second network node as a base station of a cellular network.

41. A system for performing a method of managing and triggering handover of a mobile network node in a network of moving things comprising a plurality of network nodes, the system comprising:
one or more communication interfaces configured to wirelessly communicate with the plurality of network nodes, to communicate with a satellite-based navigation receiver, and to communicate with one or more systems of a vehicle;
computer-readable memory for storing one or more software applications and program data; and
one or more processors operably coupled to the one or more communication interfaces and the computer-readable memory, the one or more processors operable to, at least:
determine a geographic location along a route of travel of a mobile network node that the mobile network node will reach due to movement of the mobile network node, wherein the mobile network node is associated with a first network node that is connected via a first data path to a remote system;
determine, before reaching the geographical location, existence of at least one condition at the geographic location, the at least one condition indicative of a likelihood of loss of wireless communication of the mobile network node with the first network node;
in response to the determining of the existence of the at least one condition, identify a second network node according to one or more characteristics of the mobile network node and one or more characteristics of the second network node, wherein the second network node is of a different type and supports a different type of network connectivity than the first network node;
based on determining that the mobile network node is approaching the geographic location along the route of travel and before a need for switching to the second network node arises, automatically prepare for handover of the mobile network node from the first network node to the second network node, the preparing comprising creating a temporary tunnel between the first network node and the second network node; and
after the mobile network node connects to the second network node:
forward data traffic communicated between the mobile network node and the remote system via the second network node, the temporary tunnel, and the first data path;
set up a second data path connecting the second network node and the remote system; and
switch forwarding of the data traffic to the second data path.

42. The system according to claim 41, wherein the one or more characteristics of the mobile network node comprise a current geographic location of the mobile network node and the one or more characteristics of the second network node comprise a current geographic location of the second network node.

43. The system according to claim 41, wherein the one or more characteristics of the mobile network node comprises a velocity of a vehicle carrying the mobile network node.

44. The system according to claim 41, wherein the one or more characteristics of the mobile network node comprise a route being traveled by a vehicle carrying the mobile network node and the one or more characteristics of the second network node comprise a current geographic location of the second network node.

45. The system according to claim 44, wherein the vehicle is an autonomous vehicle and the route being traveled is provided to the mobile network node by a navigation system of the autonomous vehicle.

46. The system according to claim 41, wherein the one or more processors are operable to identify a pattern of handover of the mobile network node at the geographic location.

47. The system according to claim 41, wherein the first network node is at a fixed location and the second network node is a second mobile network node of the plurality of network nodes.

48. The system according to claim 41, wherein the at least one condition at the mobile network node comprises a strength indication representative of a signal received from the first network node being below a first threshold.

49. The system according to claim 41, wherein the mobile network node supports wireless communication with end-user devices, and the remote system monitors the geographic location of corresponding end-user devices connected through the remote system.

50. The system according to claim 41, wherein the remote system enables seamless handover of the mobile network node from wireless communication with the first network node to wireless communication with the second network node as a base station of a cellular network.
